(19) United States
(12) Patent Application Publication
(10) Pub. No.: US 2013/0021925 A1
(43) Pub. Date: Jan. 24, 2013

(54) COORDINATED MULTIPOINT (COMP) TRANSMISSION METHOD SELECTION AND FEEDBACK REQUIREMENTS

(71) Applicants: Zhanping Yin, Vancouver, WA (US); Ahmad Khoshnevis, Portland, OR (US); Sayantan Choudhury, Berkeley, CA (US)

(72) Inventors: Zhanping Yin, Vancouver, WA (US); Ahmad Khoshnevis, Portland, OR (US); Sayantan Choudhury, Berkeley, CA (US)

(73) Assignee: Sharp Laboratories of America, Inc., Camas, WA (US)

(21) Appl. No.: 13/189,420

(22) Filed: Jul. 22, 2011

(51) Int. Cl. H04W 24/10; H04W 4/06

(52) U.S. Cl. 370/252; 370/312

(57) ABSTRACT

A method for configuring coordinated multipoint (CoMP) transmission by an eNode B is described. Feedback information is received from a user equipment (UE). A CoMP transmission measurement set is determined. The CoMP transmission measurement set is sent to the UE. A channel state information (CSI) report of the CoMP measurement set is received from the UE. A CoMP transmission method used for each CoMP transmission point in the CoMP measurement set is selected.

### TECHNICAL FIELD

The present invention relates generally to wireless communications and wireless communications-related technology. More specifically, the present invention relates to systems and methods for coordinated multipoint (CoMP) transmission method selection and feedback requirements.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of cells, each of which may be serviced by a base station. A base station may be a fixed station that communicates with mobile stations.

Various signal processing techniques may be used in wireless communication systems to improve both the efficiency and quality of wireless communications. For example, a wireless communication device may report uplink control information (UCI) to a base station. This uplink control information (UCI) may be used by the base station to select appropriate transmission modes, transmission schemes and modulation and coding schemes for downlink transmissions to the wireless communication device.

The use of coordinated multipoint (CoMP) transmission is considered a major enhancement to Long Term Evolution (LTE) Release 11. Benefits may be realized by improvements to the use of coordinated multipoint (CoMP) transmission, including better overall throughput per user.

### BRIEF DESCRIPTION OF THE DRAWINGS

FIG. 1 is a block diagram illustrating a wireless communication system that may utilize coordinated multipoint (CoMP) transmission;

FIG. 2 shows an example of a wireless communication system where coordinated multipoint (CoMP) transmission may be implemented;

FIG. 3 is a block diagram illustrating a wireless communication system using uplink control information (UCI) multiplexing;

FIG. 4 is a block diagram illustrating the layers used by a user equipment (UE);

FIG. 5 is a flow diagram of a method for configuring coordinated multipoint (CoMP) transmission and selecting the coordinated multipoint (CoMP) transmission method;

FIG. 6 is a flow diagram of a method for sending feedback corresponding to coordinated multipoint (CoMP) transmission operations;

FIG. 7 is a flow diagram of a method for configuring coordinated multipoint (CoMP) transmission;

FIG. 8 is a flow diagram of a method for determining which coordinated multipoint (CoMP) transmission candidate cells or points to be included in the coordinated multipoint (CoMP) transmission measurement set;

FIG. 9 is a flow diagram of a method for selecting a coordinated multipoint (CoMP) transmission method for a coordinated multipoint (CoMP) transmission cell or point;

FIG. 10 illustrates the coordinated multipoint (CoMP) transmission method selection of an eNode B;

FIG. 11 illustrates various components that may be utilized in a user equipment (UE); and

FIG. 12 illustrates various components that may be utilized in an eNode B.

### DETAILED DESCRIPTION

A method for configuring coordinated multipoint (CoMP) transmission by an eNode B is described. Feedback information is received from a user equipment (UE). A CoMP transmission measurement set is determined. The CoMP transmission measurement set is sent to the UE. A channel state information (CSI) report of the CoMP measurement set is received from the UE. A CoMP transmission method used for each CoMP transmission point in the CoMP measurement set is selected.

Feedback requirements may be reconfigured for each CoMP transmission point based on the selected CoMP transmission method used for each CoMP transmission point. The feedback information may include a reference signal received power (RSRP) and a reference signal received quality (RSRQ). Determining a CoMP transmission measurement set may include determining CoMP transmission candidate points of the UE and adding a CoMP transmission candidate point to the CoMP transmission measurement set if an interference level of the CoMP transmission candidate point is more than a CoMP transmission threshold.

A channel state information reference signal (CSI-RS) of the CoMP transmission points in the CoMP transmission measurement set may be configured. Selecting a CoMP transmission method may include determining whether an interference level of a CoMP transmission point with a best precoding matrix indicator (PMI) is lower than a coordinated beamforming/coordinated scheduling (CS/CB) threshold. If the interference level of the CoMP transmission point with a best PMI is be lower than the CS/CB threshold, no CoMP transmission method may be set for the CoMP transmission point. If the interference level of the CoMP transmission point with a best PMI is not lower than the CS/CB threshold, it may be determined whether an interference level of the CoMP transmission point with a worst PMI is lower than the CS/CB threshold.

If the interference level of the CoMP transmission point with a worst PMI is not lower than the CS/CB threshold, joint processing (JP) may be selected as the CoMP transmission method. If joint processing (JP) is selected as the CoMP transmission method, the eNode B may select between joint transmission (JT) and dynamic point selection (DPS) as a CoMP transmission sub-method. If the interference level of the CoMP transmission point with a worst PMI is lower than the CS/CB threshold, it may be determined whether the eNode B can schedule a suitable UE in the CoMP transmission point for CS/CB. If the eNode B can not schedule a suitable UE in the CoMP transmission point for CS/CB, joint processing (JP) may be selected as the CoMP transmission method.

If the eNode B can schedule a suitable UE in the CoMP transmission point for CS/CB, it may be determined whether increasing UE throughput is more desirable. If increasing UE throughput is more desirable, joint processing (JP) is selected as the CoMP transmission method. If increasing UE throughput is not more desirable, CS/CB may be selected as the CoMP transmission method.

The CSI report may include at least one of a relative phase between a serving cell and a CoMP transmission point, a relative signal strength between the serving cell with a best precoding matrix indicator (PMI) and a CoMP transmission point, a relative strength between a signal with a worst PMI and a best PMI of a CoMP transmission point and a relative strength between a CoMP transmission point with a worst PMI and a serving cell with a best PMI.

An eNode B for configuring coordinated multipoint (CoMP) transmission is also described. The eNode B includes a processor, memory in electronic communication with the processor and instructions stored in the memory. The instructions are executable to receive feedback information from a user equipment (UE). The instructions are also executable to determine a CoMP transmission measurement set. The instructions are further executable to send the CoMP transmission measurement set to the UE. The instructions are also executable to receive a channel state information (CSI) report of the CoMP measurement set from the UE. The instructions are further executable to select a CoMP transmission method used for each CoMP transmission point in the CoMP measurement set.

A method for sending feedback corresponding to coordinated multipoint (CoMP) transmission operations is described. Feedback information is sent to a serving cell. A CoMP transmission measurement set is received from the serving cell. Channel state information (CSI) is measured for each CoMP transmission point in the CoMP transmission measurement set. A CSI report that includes the CSI is generated. The CSI report is sent to the serving cell.

The serving cell may be an eNode B. The feedback information may include a reference signal received power (RSRP) and a reference signal received quality (RSRQ). The CSI may include a relative phase between the serving cell and a CoMP transmission point. The CSI may include a relative signal strength between the serving cell with a best precoding matrix indicator (PMI) and a CoMP transmission point. The CSI may also include a relative strength between a signal with a worst precoding matrix indicator (PMI) and a best PMI of a CoMP transmission point. The method may be performed by a user equipment (UE). The UE may be in a cell edge region. Each CoMP transmission point in the CoMP transmission measurement set may be a neighbor cell to the UE.

A user equipment (UE) configured for sending feedback corresponding to coordinated multipoint (CoMP) transmission operations is also described. The UE includes a processor, memory in electronic communication with the processor and instructions stored in the memory. The instructions are executable to send feedback information to a serving cell. The instructions are also executable to receive a CoMP transmission measurement set from the serving cell. The instructions are further executable to measure channel state information (CSI) for each CoMP transmission point in the CoMP transmission measurement set. The instructions are also executable to generate a CSI report that comprises the CSI. The instructions are further executable to send the CSI report to the serving cell.

The 3rd Generation Partnership Project, also referred to as “3GPP,” is a collaboration agreement that aims to define globally applicable technical specifications and technical reports for third and fourth generation wireless communication systems. The 3GPP may define specifications for the next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE and LTE-Advanced standards (e.g., Release-8, Release-9, Release-10 and Release-11). However, the scope of the present disclosure should not be limited in this regard. At least some aspects of the systems and methods disclosed herein may be utilized in other types of wireless communication systems.

In LTE Release-11, the use of coordinated multipoint (CoMP) transmission is a major enhancement. In coordinated multipoint (CoMP) transmission, when a user equipment (UE) is in the cell-edge region, the user equipment (UE) may be able to receive downlink signals from multiple base stations (referred to herein as points). Downlink coordinated multipoint (CoMP) transmission implies dynamic coordination among multiple geographically separated transmission points. Furthermore, uplink transmissions by the user equipment (UE) may be received by the multiple points. By coordinating the downlink transmissions from each point to the user equipment (UE), the downlink performance can be significantly increased. Likewise, by coordinating the uplink transmissions from the user equipment (UE), the multiple receiving points may take advantage of the multiple receptions to significantly improve the uplink performance. The points that are used in coordinated multipoint (CoMP) transmissions for a particular user equipment (UE) may be referred to as coordinated multipoint (CoMP) transmission points.

The use of coordinated multipoint (CoMP) transmission may increase uplink and downlink data transmission rates while ensuring consistent service quality and throughput on LTE wireless broadband networks and 3G networks. Coordinated multipoint (CoMP) transmission may be used on both the uplink and the downlink. The systems and methods discussed herein relate to downlink transmissions (i.e., transmissions from a point to a user equipment (UE)). Two major downlink coordinated multipoint (CoMP) transmission methods are under consideration: coordinated scheduling/coordinated beamforming (CS/CB) and joint processing (JP). A hybrid category of coordinated scheduling/coordinated beamforming (CS/CB) and joint processing (JP) may be possible (e.g., some points in a cooperating set may transmit data to the target user equipment (UE) according to joint processing (JP) while other points in the cooperating set perform coordinated scheduling/coordinated beamforming (CS/CB)). A cooperating set may refer to the two or more points that are cooperating to transmit data to a target user equipment (UE). A cooperating set may also be referred to as a coordinated multipoint (CoMP) transmission coordination set.

In coordinated scheduling/coordinated beamforming (CS/CB), data is only available to be transmitted from one point in the cooperating set for a time-frequency resource, as in a non-coordinated multipoint (CoMP) transmission. However, user scheduling and/or beamforming decisions may be made with coordination among points corresponding to the cooperating set to control to reduce the interference between different transmissions and minimize interference to the user equipment (UE). Thus, the best serving set of users may be selected so that the transmitter's antenna patterns' beams and nulls reduce the interference to other users. The point used may be chosen dynamically or semi-statically. With dynamic point selection (DPS), data transmission may occur from one point at a time. The transmitting point may change from one subframe to another, including varying over the resource block (RB) pairs within a subframe; however data is never available simultaneously at multiple points. In semi-static point selection (SSPS), data transmission also occurs from one point at a time. The transmitting point may only change in a semi-static manner.

In joint processing (JP), data for a user equipment (UE) may be available for transmission at more than one point in the cooperating set for a given time-frequency resource. The downlink message may be transmitted in one or multiple coordinated multipoint (CoMP) transmission cells at the same time using the same time and frequency radio resources. The cooperating set may be a set of geographically separated points directly or indirectly participating in transmission to a user equipment (UE) in a time-frequency resource. The cooperating set may or may not be transparent to the user equipment (UE) (i.e., the user equipment (UE) may not know which points are in the cooperating set). Joint processing (JP) may further be classified into two sub-methods: joint transmission (JT) and dynamic point selection (DPS).

In joint transmission (JT), data may be simultaneously transmitted from multiple points (either part or all of a cooperating set) to a single user equipment (UE) or multiple user equipments (UEs) in a time-frequency resource. Data to a user equipment (UE) may be simultaneously transmitted from multiple points (e.g., to coherently or non-coherently improve the received signal quality and/or data throughput and/or actively cancel interference for other user equipments (UEs).

In dynamic point selection (DPS), data may be transmitted from one point (within the cooperating set) in a time-frequency resource. The transmitting point may change from one subframe to another, including varying over the resource block (RB) pairs within a subframe. Data may be available simultaneously at multiple points. This includes dynamic cell selection (DCS), in which transmission is performed by only the cell with the best channel quality among the coordinated multipoint (CoMP) transmission cells. Dynamic point selection (DPS) may be combined with joint transmission (JT), in which case multiple points may be selected for data transmission in the time-frequency resource.

Simulations to evaluate the benefit of each coordinated multipoint (CoMP) transmission method under different scenarios, assuming only a fixed coordinated multipoint (CoMP) transmission method is used in all cells, have shown significant improvement on cell edge user equipments (UEs). Since each coordinated multipoint (CoMP) transmission method has its own advantages and disadvantages, the best system performance may be achieved when coordinated multipoint (CoMP) transmission is configured and the coordinated multipoint (CoMP) transmission method is selected appropriately based on the channel conditions observed at each user equipment (UE) in the network. Thus, each user equipment (UE) may collect channel condition information and provide this information to a base station. The base station may then select whether coordinated multipoint (CoMP) transmission is enabled, and the specific coordinated multipoint (CoMP) transmission method for each point used when coordinated multipoint (CoMP) transmission is enabled. Hybrid categories of joint processing (JP) and coordinated scheduling/coordinated beamforming (CS/CB) may be possible (e.g., some points may transmit data to the target user equipment (UE) according to joint processing (JP) while other points in the cooperating set perform coordinated scheduling/coordinated beamforming (CS/CB).

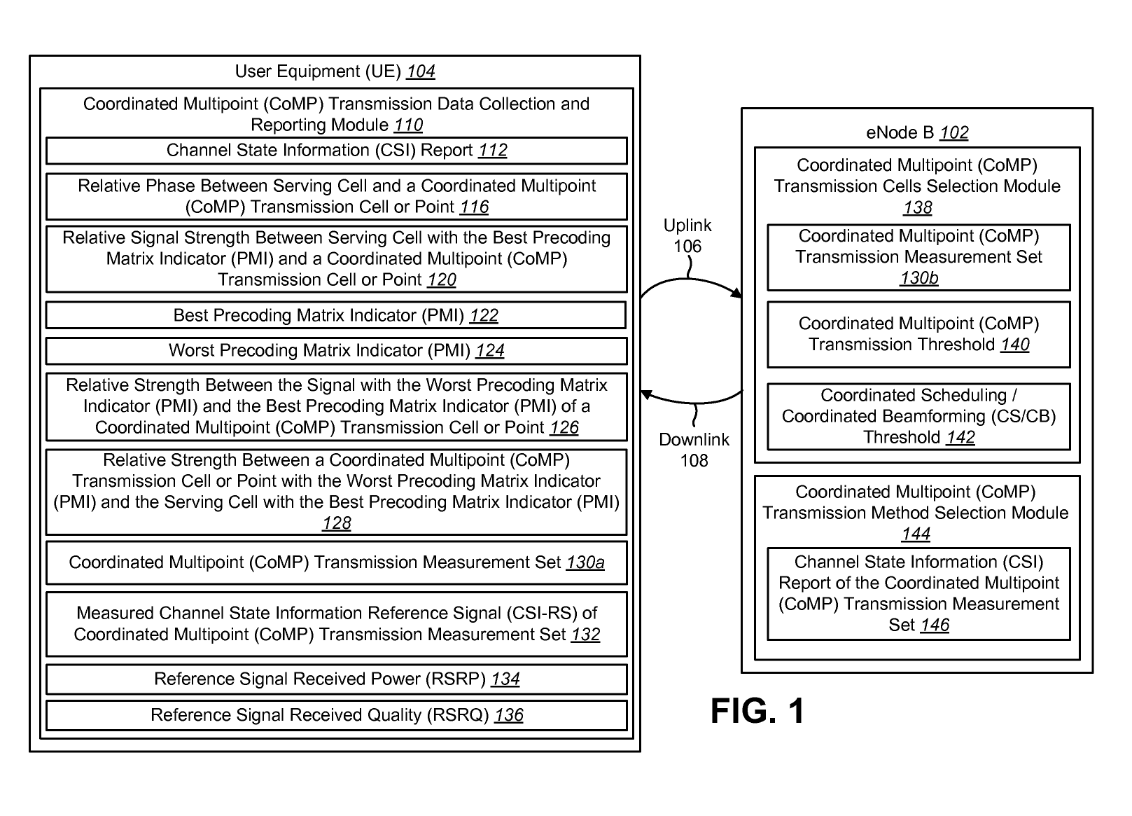

FIG. 1 is a block diagram illustrating a wireless communication system 100 that may utilize coordinated multipoint (CoMP) transmission. The wireless communication system 100 may include an eNode B 102 in communication with a user equipment (UE) 104. An eNode B 102 may be referred to as an access point, a Node B, a base station or some other terminology. Likewise, a user equipment (UE) 104 may be referred to as a mobile station, a subscriber station, an access terminal, a remote station, a user terminal, a terminal, a handset, a subscriber unit, a wireless communication device or some other terminology.

Communication between a user equipment (UE) 104 and an eNode B 102 may be accomplished using transmissions over a wireless link, including an uplink 106 and a downlink 108. The uplink 106 refers to communications sent from a user equipment (UE) 104 to an eNode B 102. The downlink 108 refers to communications sent from an eNode B 102 to a user equipment (UE) 104.

In general, the communication link may be established using a single-input and single-output (SISO), multiple-input and single-output (MISO), single-input and multiple-output (SIMO) or a multiple-input and multiple-output (MIMO) system. A MIMO system may include both a transmitter and a receiver equipped with multiple transmit and receive antennas. Thus, an eNode B 102 may have multiple antennas and a user equipment (UE) 104 may have multiple antennas (not shown). In this way, an eNode B 102 and a user equipment (UE) 104 may each operate as either a transmitter or a receiver in a MIMO system. One benefit of a MIMO system is improved performance if the additional dimensionalities created by the multiple transmit and receive antennas are utilized.

There has recently been a lot of interest in coordinated multipoint (CoMP) transmission schemes where multiple transmission points cooperate. There has also been discussion on how to improve the feedback scheme for both coordinated multipoint (CoMP) transmission and multiuser MIMO schemes. The coordinated multipoint (CoMP) transmission operation and coordinated multipoint (CoMP) transmission method used are user equipment (UE)-specific problems. The eNode B 102 may make a decision concerning the use of coordinated multipoint (CoMP) transmission and the coordinated multipoint (CoMP) transmission method used based on feedback from the user equipment (UE) 104. Depending on the channel conditions observed by a user equipment (UE) 104, coordinated multipoint (CoMP) transmission operation and the coordinated multipoint (CoMP) transmission method of each point may be configured dynamically and independently.

The user equipment (UE) 104 may include a coordinated multipoint (CoMP) transmission data collection and reporting module 110. The coordinated multipoint (CoMP) transmission data collection and reporting module 110 may assist the user equipment (UE) 104 in gathering additional information that may be useful to an eNode B 102 that is determining whether to enable coordinated multipoint (CoMP) transmission for the user equipment (UE) 104 and what coordinated multipoint (CoMP) transmission method to use. In general, coordinated multipoint (CoMP) transmission operation should be used when the signals from neighbor points or cells cause interference to the signals between the serving cell (i.e., the eNode B 102) and the user equipment (UE) 104. Therefore, the relative signal strength between the signals received at the user equipment (UE) 104 from the serving eNode B 102 and the signals received at the user equipment (UE) 104 from a neighboring interfering cell or point may be used to determine if coordinated multipoint (CoMP) transmission should be applied in the downlink 108 for the user equipment (UE) 104.

The coordinated multipoint (CoMP) transmission data collection and reporting module 110 may include a channel state information (CSI) report 112. In Release-10, a user equipment (UE) 104 may feedback periodic channel state information (CSI) reports 112 on the physical uplink control channel (PUCCH) for the eNode B 102. A channel state information (CSI) report 112 may include feedback information for the eNode B 102. Examples of feedback information include the rank indication (RI), the precoding matrix indicator (PMI) and the channel quality indicator (Cal). The rank indication (RI) may represent the number of layers that can be supported on the channel. The precoding matrix indicator (PMI) may report an index for a precoding matrix that gives the best received signal at the user equipment (UE) 104. The channel quality indicator (CQI) may be calculated based on the best precoding matrix indicator (PMI) selection. For multiple layer transmissions, the channel quality indicator (CQI) of each layer may be reported. The channel quality indicator (CQI) feedback of Release 10 represents the signal quality at the receiver; mathematically, it is a quantized feedback of Ps_max/noise, where the noise includes interference from neighbor cells or points and where Ps_max is the received power of the serving cell with the best precoding matrix indicator (PMI)). In coordinated multipoint (CoMP) transmissions, the channel state information (CSI) of each coordinated cell or point may be reported separately or jointly with the same format as Release-10 or new formats.

However, to support coordinated multipoint (CoMP) transmission operations and coordinated multipoint (CoMP) transmission method selection, the user equipment (UE) 104 may collect additional information besides the Release 10 feedback. For example, the user equipment (UE) 104 may obtain the relative phase 116 between the serving cell and a coordinated multipoint (CoMP) transmission cell or point. The user equipment (UE) 104 may also obtain the relative signal strength 120 between the serving cell with the best precoding matrix indicator (PMI) and a coordinated multipoint (CoMP) transmission cell or point. The relative signal strength 120 may be represented with quantized relative amplitude or quantized relative power. The user equipment (UE) 104 may further obtain the best precoding matrix indicator (PMI) 122 (referred to as PMIc_max) and the worst precoding matrix indicator (PMI) 124 (referred to as PMIc_ml n).

The best precoding matrix indicator (PMI) 122 of a coordinated multipoint (CoMP) transmission cell or point may be the precoding matrix indicator (PMI) that maximizes the received signal strength of a coordinated multipoint (CoMP) transmission cell or point. The format and method to obtain the best precoding matrix indicator (PMI) 122 of a coordinated multipoint (CoMP) transmission cell or point may be the same as used in Release 10.

In one configuration, the worst precoding matrix indicator (PMI) 124 may be the precoding matrix indicator (PMI) that minimizes the received signal strength of a coordinated multipoint (CoMP) transmission cell or point. In another configuration, the worst precoding matrix indicator (PMI) 124 may be a set of precoding matrix indicators (PMIs) that minimizes the received signal strength of a coordinated multipoint (CoMP) transmission cell or point. Providing a subset of precoding matrix indicators (PMIs) gives more flexibility to the eNode B 102 scheduler for coordinated scheduling/coordinated beamforming (CS/CB) operation. In yet another configuration, the worst precoding matrix indicator (PMI) 124 (or precoding matrix indicator (PMI) set) may be implicitly defined by the best precoding matrix indicator (PMI) 122. Thus, the worst precoding matrix indicator (PMI) 124 set may include all precoding matrix indicators (PMIs) that are orthogonal to the best precoding matrix indicator (PMI) 122.

The user equipment (UE) 104 may also obtain the relative strength 126 between the signal with the worst precoding matrix indicator (PMI) 124 and the best precoding matrix indicator (PMI) 122 of a coordinated multipoint (CoMP) transmission cell or point. Relative strength may be used to indicate the relative strength 126 between the signal with the worst precoding matrix indicator (PMI) 124 and the best precoding matrix indicator (PMI) 122 of a coordinated multipoint (CoMP) transmission cell or point. The relative strength may be represented by a relative power or a relative amplitude using a quantization method. The quantization method is outside of the scope of this disclosure.

The relative strength 126 between the signal with the worst precoding matrix indicator (PMI) 124 and the best precoding matrix indicator (PMI) 122 of a coordinated multipoint (CoMP) transmission cell or point may be used to indicate the effectiveness of coordinated scheduling/coordinated beamforming (CS/CB). If the ratio of the relative strength 126 between the signal with the worst precoding matrix indicator (PMI) 124 and the best precoding matrix indicator (PMI) 122 of a coordinated multipoint (CoMP) transmission cell or point is low, the interference level can be reduced significantly by null beamforming.

If the ratio of the relative strength 126 between the signal with the worst precoding matrix indicator (PMI) 124 and the best precoding matrix indicator (PMI) 122 of a coordinated multipoint (CoMP) transmission cell or point is high, the coordinated scheduling/coordinated beamforming (CS/CB) may be unable to effectively reduce the interference using beamforming (i.e., even with the precoding matrix indicator (PMI) that minimizes the interferences, the interference level is still unacceptable). Thus, when the ratio of the relative strength 126 between the signal with the worst precoding matrix indicator (PMI) 124 and the best precoding matrix indicator (PMI) 122 of a coordinated multipoint (CoMP) transmission cell or point is high, joint processing (JP) may be applied on the given channel.

However, the serving eNode B 102 has full control over the coordinated multipoint (CoMP) transmission method selection. For example, the serving eNode B 102 may choose joint transmission (JT) even if the interference level with coordinated scheduling/coordinated beamforming (CS/CB) is acceptable when increasing user equipment (UE) 104 throughput is more desirable and/or the eNode B 102 cannot schedule a suitable user equipment (UE) 104 in a coordinated multipoint (CoMP) transmission cell or point to perform the coordinated scheduling/coordinated beamforming (CS/CB).

The user equipment (UE) 104 may further obtain the relative strength 128 between a coordinated multipoint (CoMP) transmission cell or point with the worst precoding matrix indicator (PMI) 124 and the serving cell or point with the best precoding matrix indicator (PMI) 122.

The user equipment (UE) 104 may receive a coordinated multipoint (CoMP) transmission measurement set 130a from the serving eNode B 102. As used herein, a coordinated multipoint (CoMP) transmission coordination set is the cells that are coordinated under one eNode B 102 scheduler (e.g., N cells (N=3, 9, 19, 21, 57 are considered, with N=9 as the baseline for high power remote radio head (RRH) settings)). The coordinated multipoint (CoMP) transmission measurement set 130a0b may also be referred to as the control signaling points. The coordinated multipoint (CoMP) transmission measurement set 130a-b includes the cells that a user equipment (UE) 104 monitors and measures (e.g., L cells with L≦N). When there is a large coordinated multipoint (CoMP) transmission coordination area, L may be much smaller than N. A coordinated multipoint (CoMP) transmission reporting set refers to the cells that a user equipment (UE) 104 reports about in feedback (e.g., M cells). The coordinated multipoint (CoMP) transmission reporting set is a subset of the coordinated multipoint (CoMP) transmission measurement set 130 (thus, M≦L). A coordinated multipoint (CoMP) transmission set refers to the cells that the eNode B 102 schedules for transmission (e.g., K cells). The coordinated multipoint (CoMP) transmission set is a subset of the reporting set (thus K≦M).

The user equipment (UE) 104 may receive the coordinated multipoint (CoMP) transmission measurement set 130a from the serving eNode B 102 in response to feedback sent from the user equipment (UE) 104 to the serving eNode B 102. The user equipment (UE) 104 may measure the channel state information reference signal (CSI-RS) 132 of the coordinated multipoint (CoMP) transmission measurement set 130 and generate a channel state information (CSI) report 112 of these cells based on the feedback configuration from the eNode B 102. The channel state information reference signal (CSI-RS) 132 is a new UE-specific reference signal introduced in Release-10, mainly for multiple antenna operations. Thus, a Release-10 user equipment (UE) 104 may measure the channel based on the channel state information reference signal (CSI-RS) 132 instead of the common reference signal (CRS).

The eNode B 102 may also configure the number of coordinated multipoint (CoMP) transmission reporting cells or points M of a user equipment (UE) 104. If the number of coordinated multipoint (CoMP) transmission reporting cells or points M is smaller than the number of coordinated multipoint (CoMP) transmission measurement cells L 130a, the user equipment (UE) 104 may report the M cells or points with the highest interference levels.

The user equipment (UE) 104 may also include the reference signal received power (RSRP) 134 and the reference signal received quality (RSRQ) 136. The reference signal received power (RSRP) 134 refers to the average of the power of all resource elements. The reference signal received quality (RSRQ) 136 refers to the ratio between the reference signal received power (RSRP) 134 and the received signal strength indicator (RSSI). Currently, the reference signal received power (RSRP) 134 and reference signal received quality (RSRQ) 136 are mainly used to evaluate which cell provides the best serving condition (i.e., for cell selection and handover). The reference signal received power (RSRP) 134 and the reference signal received quality (RSRQ) 136 may be sent to the serving eNode B 102.

The relative phase 116 between the serving cell and the coordinated multipoint (CoMP) transmission cell or point, relative signal strength 120 between the serving cell with the best precoding matrix indicator (PMI) 122 and the coordinated multipoint (CoMP) transmission cell or point, the relative strength 126 between the signal with the worst precoding matrix indicator (PMI) 124 and the best precoding matrix indicator (PMI) 122 of the coordinated multipoint (CoMP) transmission cell or point and the relative strength 128 between the coordinated multipoint (CoMP) transmission cell or point with the worst precoding matrix indicator (PMI) 124 and the serving cell with the best precoding matrix indicator (PMI) 122 may all be placed in the channel state information (CSI) report 112. The channel state information (CSI) report 112 may then be sent to an eNode B 102.

The serving eNode B 102 may include a coordinated multipoint (CoMP) transmission cells selection module 138. Upon receiving the reference signal received power (RSRP) 134 and the reference signal received quality (RSRQ) 136 for neighbor cells to the user equipment (UE) 104 from the user equipment (UE) 104 (referred to as a neighbor cell list), the eNode B 102 may use the coordinated multipoint (CoMP) transmission cells selection module 138 to determine a coordinated multipoint (CoMP) transmission measurement set 130b. The eNode B 102 may have knowledge of the coordinated multipoint (CoMP) transmission coordination set under its control. Upon receiving the neighbor cell list of a user equipment (UE) 104, the eNode B 102 can first determine the coordinated multipoint (CoMP) transmission candidate cells or points of the user equipment (UE) as the intersection of the user equipment (UE) 104 neighbor cells and the coordinated multipoint (CoMP) transmission coordination set of the eNode B 102. For each cell or point in the coordinated multipoint (CoMP) transmission candidate cells or points, the eNode B 102 may evaluate if the interference level from this cell or point is more than a coordinated multipoint (CoMP) transmission threshold 140.

In one configuration, the interference level may be evaluated as the ratio between the reference signal received power (RSRP) 134 of a coordinated multipoint (CoMP) transmission candidate cell or point and the reference signal received power (RSRP) 134 of the serving cell of the user equipment (UE) 104. In another configuration, the interference level may be an absolute value. If the interference level of a coordinated multipoint (CoMP) transmission candidate cell or point is more than a coordinated multipoint (CoMP) transmission threshold 140, the coordinated multipoint (CoMP) transmission candidate cell or point may be included in the coordinated multipoint (CoMP) transmission measurement set 130b. When the coordinated multipoint (CoMP) transmission measurement set 130b is defined, the eNode B 102 may configure the channel state information reference signal (CSI-RS) of each cell or point in the coordinated multipoint (CoMP) transmission measurement set 130b. The eNode B 102 may send the coordinated multipoint (CoMP) transmission measurement set 130b to the user equipment (UE) 104 so that the user equipment (UE) 104 can measure the channel state information reference signal (CSI-RS) 132 of the coordinated multipoint (CoMP) transmission measurement set 130a.

The serving eNode B 102 may also include a coordinated multipoint (CoMP) transmission method selection module 144. The coordinated multipoint (CoMP) transmission method selection module 144 may receive the measured channel state information (CSI) report 146 of the coordinated multipoint (CoMP) transmission measurement set 130 from the user equipment (UE) 104. The coordinated multipoint (CoMP) transmission method selection module 144 may then select the coordinated multipoint (CoMP) transmission method. As discussed above, the two major coordinated multipoint (CoMP) transmission methods include coordinated scheduling/coordinated beamforming (CS/CB) and joint processing (JP). Both coordinated scheduling/coordinated beamforming (CS/CB) and joint processing (JP) may have sub-methods. When determining whether to use coordinated scheduling/coordinated beamforming (CS/CB) or joint processing (JP), the eNode B 102 may compare the interference with a coordinated beamforming/coordinated scheduling (CS/CB) threshold 142. If the interference is greater than the coordinated beamforming/coordinated scheduling (CS/CB) threshold 142, joint processing (JP) may be selected for a cell or point.

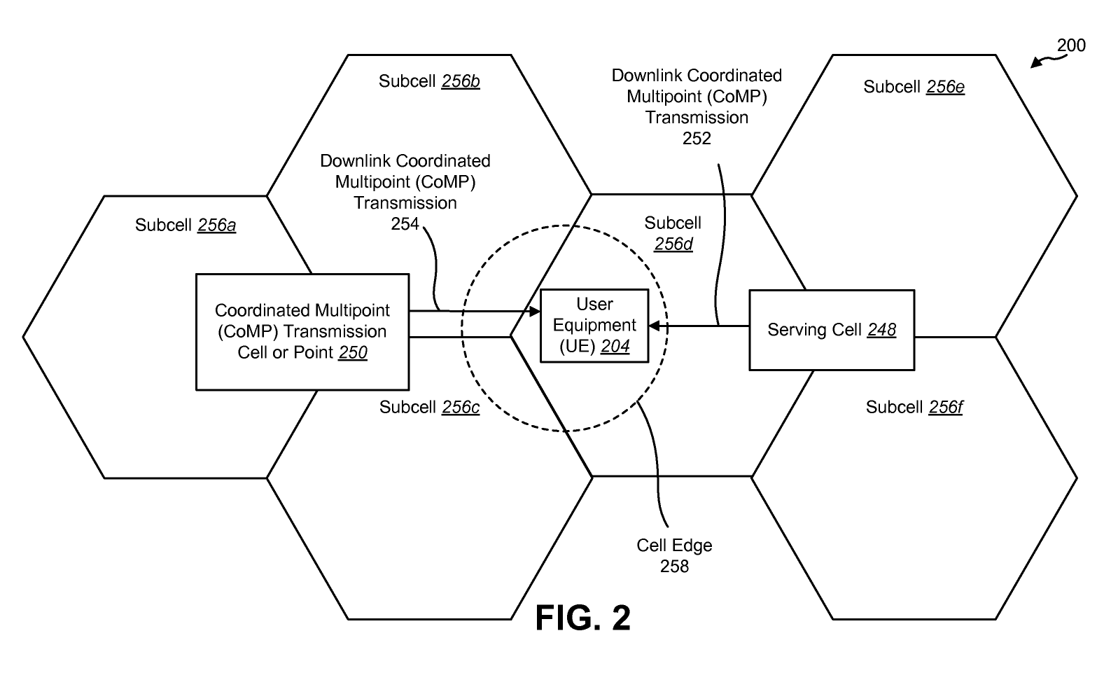

FIG. 2 shows an example of a wireless communication system 200 where coordinated multipoint (CoMP) transmission may be implemented. The wireless communication system 200 includes a serving cell 248 that is serving a user equipment (UE) 204 and a neighbor cell that is near the user equipment (UE). The neighbor cell may be a coordinated multipoint (CoMP) transmission cell or point 250. Both the serving cell 248 and the coordinated multipoint (CoMP) transmission cell or point 250 may provide communication coverage for particular geographic areas. Strictly speaking, the serving cell 248 (or serving point) is a coordinated multipoint (CoMP) transmission cell or point. The terms serving cell 248 and serving point are used to denote that the serving cell 248 or serving point is the transmission point to which the user equipment (UE) 204 is attached (i.e., the serving cell 248 is the cell with which the main control signaling transpires). However, for the sake of simplicity, the serving cell 248 and the coordinated multipoint (CoMP) transmission cells or points 250 are denoted separately herein.

To improve system capacity, the coverage areas of a cell may be partitioned into three subcells 256a-f. Thus, a cell may have a coverage area that includes three subcells 256. The term “cell” can refer to an eNode B 102 and its coverage area, depending on the context in which the term is used. The term “cell” may also refer to a component carrier (CC) used in carrier aggregation.

When a user equipment (UE) 204 is in a region referred to as a cell edge 258, the user equipment (UE) 204 may be capable of communicating with multiple cells. For example, the user equipment (UE) 204 in FIG. 2 may communicate with both the serving cell 248 and the coordinated multipoint (CoMP) transmission cell or point 250. When the user equipment (UE) 204 is capable of communicating with multiple cells or points, coordinated multipoint (CoMP) transmission may be enabled. The enabling of coordinated multipoint (CoMP) transmission may be exclusively decided by the serving cell 248. The serving cell 248 may also select a coordinated multipoint (CoMP) transmission method.

In the coordinated multipoint (CoMP) transmission method coordinated scheduling/coordinated beamforming (CS/CB), the user equipment (UE) 204 may receive a downlink coordinated multipoint (CoMP) transmission 252 from only the serving cell 248. The coordinated multipoint (CoMP) transmission cell or point 250 may schedule transmissions with beamforming that minimize interference to the user equipment (UE) 204. In the coordinated multipoint (CoMP) transmission method joint processing (JP), one or multiple downlink coordinated multipoint (CoMP) transmissions are transmitted to the user equipment (UE) 204 from the serving cell 248 and/or one or more coordinated multipoint (CoMP) transmission cells or points 250 (shown as downlink coordinated multipoint (CoMP) transmission 252 and downlink coordinated multipoint (CoMP) transmission 254 respectively). The first downlink coordinated multipoint (CoMP) transmission 252 and the secondary downlink coordinated multipoint (CoMP) transmission 254 may use the same time and frequency radio resources. If joint processing (JP) with dynamic point selection (DPS) is used, the data may be transmitted by only one cell or point of the coordinated multipoint (CoMP) cells or points.

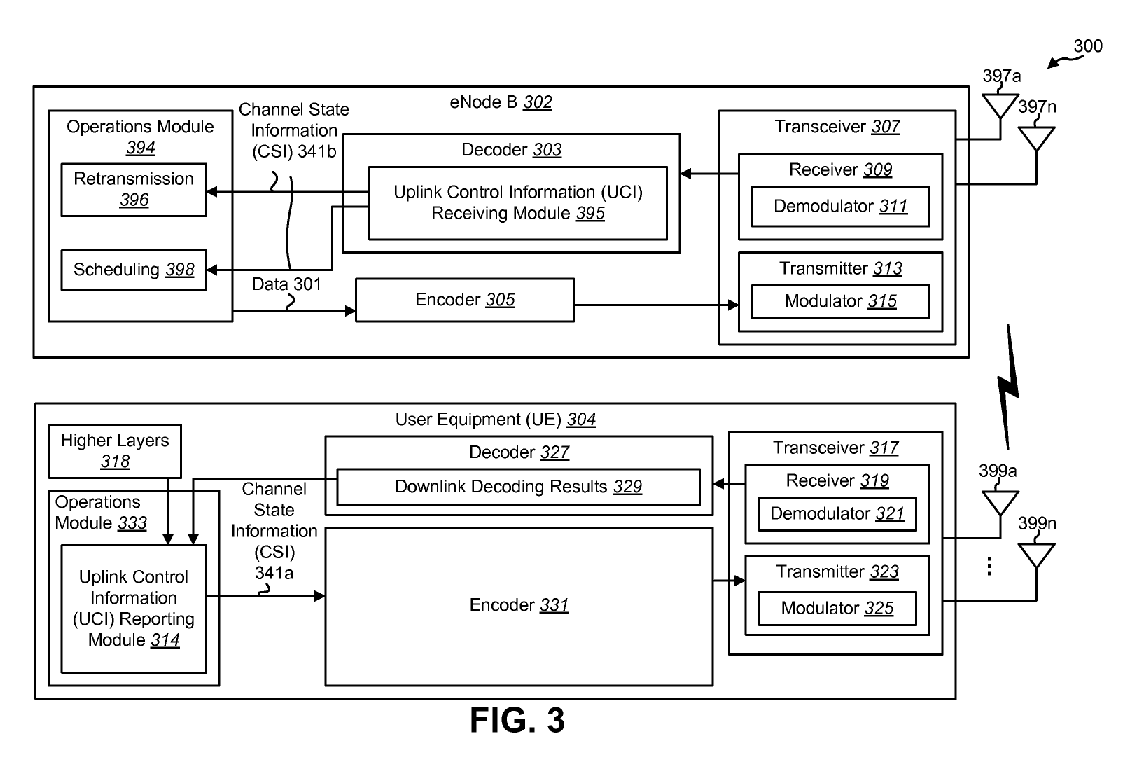

FIG. 3 is a block diagram illustrating a wireless communication system 300 using uplink control information (UCI) multiplexing. An eNode B 302 may be in wireless communication with one or more user equipments (UEs) 304. The eNode B 302 of FIG. 3 may be one configuration of the eNode B 102 of FIG. 1. The user equipment (UE) 304 of FIG. 3 may be one configuration of the user equipment (UE) 104 of FIG. 1.

The user equipment (UE) 304 communicates with the eNode B 302 using one or more antennas 399a-n. The user equipment (UE) 304 may include a transceiver 317, a decoder 327, an encoder 331 and an operations module 333. The transceiver 317 may include a receiver 319 and a transmitter 323. The receiver 319 may receive signals from the eNode B 302 using one or more antennas 399a-n. For example, the receiver 319 may receive and demodulate received signals using a demodulator 321. The transmitter 323 may transmit signals to the eNode B 302 using one or more antennas 399a-n. For example, the transmitter 323 may modulate signals using a modulator 325 and transmit the modulated signals.

The receiver 319 may provide a demodulated signal to the decoder 327. The user equipment (UE) 304 may use the decoder 327 to decode signals and make downlink decoding results 329. The downlink decoding results 329 may indicate whether data was received correctly. For example, the downlink decoding results 329 may indicate whether a packet was correctly or erroneously received (i.e., positive acknowledgement, negative acknowledgement or discontinuous transmission (no signal)).

The operations module 333 may be a software and/or hardware module used to control user equipment (UE) 304 communications. For example, the operations module 333 may determine when the user equipment (UE) 304 requires resources to communicate with an eNode B 302. The operations module 333 may receive instructions from higher layers 318.

The user equipment (UE) 304 may transmit uplink control information (UCI) to an eNode B 302 on the uplink. The uplink control information (UCI) may include channel state information (CSI) 341a in a channel state information (CSI) report 112, as discussed above in relation to FIG. 1. The uplink control information (UCI) may be transmitted on either the physical uplink control channel (PUCCH) or the physical uplink shared channel (PUSCH). The uplink control information (UCI) may be reported from a user equipment (UE) 304 to an eNode B 302 either periodically or aperiodically.

The channel state information (CSI) 341a may be generated by the uplink control information (UCI) reporting module 314 and transferred to an encoder 331. The encoder 331 may generate uplink control information (UCI) using backwards compatible physical uplink control channel (PUCCH) formats and physical uplink shared channel (PUSCH) formats. Backwards compatible physical uplink control channel (PUCCH) formats are those formats that may be used by Release-10 user equipments (UEs) 304 as well as Release-8/9 user equipments (UEs) 304.

The time and frequency resources may be quantized to create a grid known as the Time-Frequency grid. In the time domain, 10 milliseconds (ms) is referred to as one radio frame. One radio frame may include 10 subframes, each with a duration of 1 ms, which is the duration of transmission in the uplink and/or downlink. Every subframe may be divided into two slots, each with a duration of 0.5 ms. Each slot may be divided into seven symbols. The frequency domain may be divided into bands with a 15 kilohertz (kHz) width, referred to as a subcarrier. One resource element has a duration of one symbol in the time domain and the bandwidth of one subcarrier in the frequency domain.

The minimum amount of resource that can be allocated for the transmission of information in the uplink or downlink in any given subframe is two resource blocks (RBs), one RB at each slot. One RB has a duration of 0.5 ms (seven symbols or one slot) in the time domain and a bandwidth of 12 subcarriers (180 kHz) in the frequency domain. At any given subframe, a maximum of two RBs (one RB at each slot) can be used by a given user equipment (UE) 304 for the transmission of uplink control information (UCI) in the physical uplink control channel (PUCCH).

An eNode B 302 may include a transceiver 307 that includes a receiver 309 and a transmitter 313. An eNode B 302 may additionally include a decoder 303, an encoder 305 and an operations module 394. An eNode B 302 may receive uplink control information (UCI) using multiple antennas 397a-n and a receiver 309. The receiver 309 may use the demodulator 311 to demodulate the uplink control information (UCI).

The decoder 303 may include an uplink control information (UCI) receiving module 395. An eNode B 302 may use the uplink control information (UCI) receiving module 395 to decode and interpret the uplink control information (UCI) received by the eNode B 302. The eNode B 302 may use the decoded uplink control information (UCI) to perform certain operations, such as retransmit one or more packets based on scheduled communication resources for the user equipment (UE) 304. The uplink control information (UCI) may include channel state information (CSI) 341b such as that discussed above in relation to FIG. 1.

The operations module 394 may include a retransmission module 396 and a scheduling module 398. The retransmission module 396 may determine which packets to retransmit (if any) based on the uplink control information (UCI). The scheduling module 398 may be used by the eNode B 302 to schedule communication resources (e.g., bandwidth, time slots, frequency channels, spatial channels, etc.). The scheduling module 398 may use the uplink control information (UCI) to determine whether (and when) to schedule communication resources for the user equipment (UE) 304.

The operations module 394 may provide data 301 to the encoder 305. For example, the data 301 may include packets for retransmission and/or a scheduling grant for the user equipment (UE) 304. The encoder 305 may encode the data 301, which may then be provided to the transmitter 313. The transmitter 313 may modulate the encoded data using the modulator 315. The transmitter 313 may transmit the modulated data to the user equipment (UE) 304 using the antennas 397a-d.

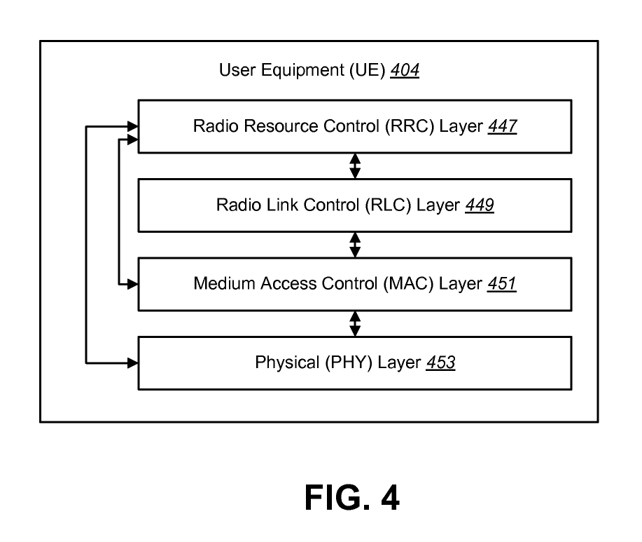

FIG. 4 is a block diagram illustrating the layers used by a user equipment (UE) 404. The user equipment (UE) 404 of FIG. 4 may be one configuration of the user equipment (UE) 104 of FIG. 1. The user equipment (UE) 404 may include a radio resource control (RRC) layer 447, a radio link control (RLC) layer 449, a medium access control (MAC) layer 451 and a physical (PHY) layer 453. These layers may be referred to as higher layers 318. The user equipment (UE) 404 may include additional layers not shown in FIG. 4.

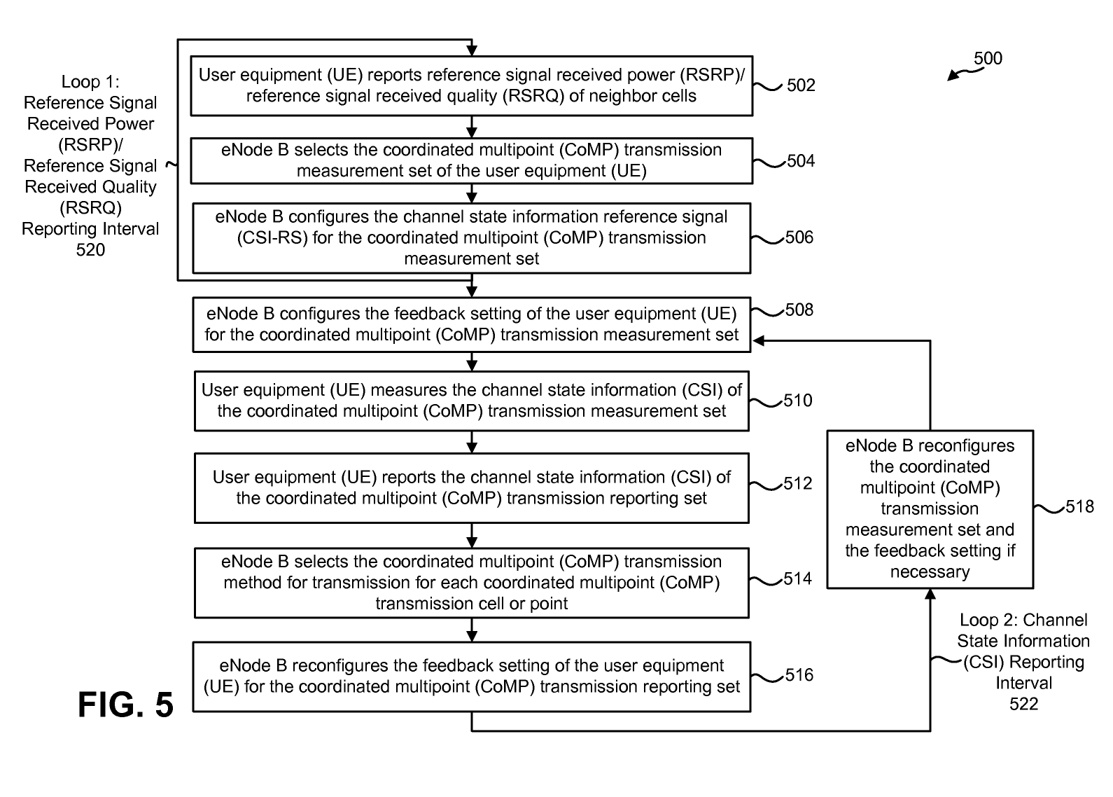

FIG. 5 is a flow diagram of a method 500 for configuring coordinated multipoint (CoMP) transmission and selecting the coordinated multipoint (CoMP) transmission method. In a first loop 520, referred to as a reference signal received power (RSRP)/reference signal received quality (RSRQ) reporting interval, a user equipment (UE) 104 may report 502 the reference signal received power (RSRP) 134 and reference signal received quality (RSRQ) 136 of neighbor cells to a serving eNode B 102. Based on the reference signal received power (RSRP) 134 and the reference signal received quality (RSRQ) 136, the serving eNode B 102 may select 504 the coordinated multipoint (CoMP) transmission measurement set 130 for the user equipment (UE) 104. The serving eNode B 102 may also configure 506 the channel state information reference signal (CSI-RS) for the coordinated multipoint (CoMP) transmission measurement set 130. The first loop 520 may repeat and the second loop 522 may start.

In the second loop 522, referred to as the channel state information (CSI) reporting interval, the serving eNode B 102 may configure 508 the feedback setting of the user equipment (UE) 104 for the coordinated multipoint (CoMP) transmission measurement set 130. The feedback setting of the user equipment (UE) 104 for the coordinated multipoint (CoMP) transmission measurement set 130 may define which information (i.e., the channel state information (CSI)) the user equipment (UE) 104 is to feedback to the serving eNode B 102. The user equipment (UE) 104 may measure 510 the channel state information (CSI) of the coordinated multipoint (CoMP) transmission measurement set 130. The user equipment (UE) 104 may then report 512 the channel state information (CSI) of the coordinated multipoint (CoMP) transmission measurement set 130 to the serving eNode B 102.

The serving eNode B 102 may select 514 the coordinated multipoint (CoMP) transmission method for each coordinated multipoint (CoMP) transmission cell or point 250 (i.e., for each neighbor cell or point that coordinated multipoint (CoMP) transmission has been enabled for). The coordinated multipoint (CoMP) transmission operation and settings are user equipment (UE) 104 specific. The serving eNode B 102 may decide whether coordinated multipoint (CoMP) transmission is used and the coordinated multipoint (CoMP) transmission method for all of the coordinated multipoint (CoMP) transmission cells or points 250 of a given user equipment (UE) 104. The serving eNode B 102 may reconfigure 516 the feedback setting of the user equipment (UE) 104 for the coordinated multipoint (CoMP) transmission measurement set 130 based on the selected coordinated multipoint (CoMP) transmission method.

For example, if joint processing (JP) with joint transmission (JT) is selected as the coordinated multipoint (CoMP) transmission method for a coordinated multipoint (CoMP) transmission cell or point 250, the eNode B 102 may configure the channel state information (CSI) report of the coordinated multipoint (CoMP) transmission cell or point 250 to include the best precoding matrix indicator (PMI) 122 and the relative phase 116 between the serving cell 248 and the coordinated multipoint (CoMP) transmission cell or point 250. As another example, if coordinated scheduling/coordinated beamforming (CS/CB) is selected as the coordinated multipoint (CoMP) transmission method for a coordinated multipoint (CoMP) transmission cell or point 250, the eNode B 102 may configure the channel state information (CSI) report of the coordinated multipoint (CoMP) transmission cell or point 250 to include the worst precoding matrix indicator (PMI) 124 and the relative strength 128 between the coordinated multipoint (CoMP) transmission cell or point 250 with the worst precoding matrix indicator (PMI) 124 and the serving cell 248. The coordinated multipoint (CoMP) transmission method of each cell can be configured independently. Thus, an eNode B 102 may set different coordinated multipoint (CoMP) transmission method for different cells or points in a coordinated multipoint (CoMP) transmission set.

Different feedback information may be needed by the eNode B 102 at different stages. Therefore, the eNode B 102 may configure different feedback settings for different coordinated multipoint (CoMP) transmission reporting sets. The coordinated multipoint (CoMP) transmission method of each cell or point may be configured independently. Thus, the eNode B 102 may set different coordinated multipoint (CoMP) transmission methods for different cells or points in a coordinated multipoint (CoMP) transmission measurement set 130. For example, if two cells or points are using coordinated multipoint (CoMP) transmission in addition to the serving cell 248, one of the coordinated multipoint (CoMP) transmission cells or points 250 may use coordinated scheduling/coordinated beamforming (CS/CB) and the other coordinated multipoint (CoMP) transmission cell or point 250 may use joint transmission (JT).

The eNode B 102 may schedule with a longer interval for the parameters to select the coordinated multipoint (CoMP) transmission method used in coordinated multipoint (CoMP) transmission cells or points 250. As discussed above, the user equipment (UE) 104 may report 512 the channel state information (CSI) of the coordinated multipoint (CoMP) transmission reporting set 130 to the serving eNode B 102. The channel state information (CSI) may include different types of information with different intervals. For example, the rank indication (RI) does not need to be reported as frequently as the CQI/PMI. Thus, the rank indication (RI) has a longer report interval than the CQI/PMI. Similarly, for coordinated multipoint (CoMP) feedback, the information used to determine the coordinated multipoint (CoMP) transmission method may have a longer interval while the detailed information for a selected coordinated multipoint (CoMP) transmission method may have a shorter interval.

The eNode B 102 may use a longer interval for the relative strength between the serving cell 248 and a coordinated multipoint (CoMP) transmission cell or point 250 or for the relative strength within a coordinated multipoint (CoMP) transmission cell or point 250 between the best precoding matrix indicator (PMI) 122 and the worst precoding matrix indicator (PMI) 124. The eNode B 102 may schedule with a shorter interval for the parameters of a coordinated multipoint (CoMP) transmission cell or point 250 with a given coordinated multipoint (CoMP) transmission method.

Depending on the selected coordinated multipoint (CoMP) transmission method, the eNode B 102 may configure different report parameters for different coordinated multipoint (CoMP) transmission cells or points 250. For example, a user equipment (UE) 104 communicating with a coordinated multipoint (CoMP) transmission cell or point 250 configured for joint processing (JP) with joint transmission (JT) may report the best precoding matrix indicator (PMI) 122, channel quality indicator (CQI) and relative phase 116 between the serving cell 248 and the coordinated multipoint (CoMP) transmission cell or point 250.

A user equipment (UE) 104 communication with a coordinated multipoint (CoMP) transmission cell or point 250 configured for joint processing (JP) with dynamic point selection (DPS) may report the best precoding matrix indicator (PMI) 122 and channel quality indicator (CQI) but not the relative phase 116 between the serving cell 248 and the coordinated multipoint (CoMP) transmission cell or point 250.

A user equipment (UE) 104 communicating with a coordinated multipoint (CoMP) transmission cell or point 250 configured for coordinated scheduling/coordinated beamforming (CS/CB) may report the worst precoding matrix indicator (PMI) 124 and the relative strength between the worst precoding matrix indicator (PMI) 124 and the best precoding matrix indicator (PMI) 122 of the coordinated multipoint (CoMP) transmission cell or point 250 and/or the serving cell 248.

The serving eNode B 102 may also reconfigure 518 the coordinated multipoint (CoMP) transmission measurement set 130 and the feedback setting of the user equipment (UE) 104, if necessary. For example, the eNode B 102 may remove a cell from the coordinated multipoint (CoMP) transmission measurement set 130 if the interference level for the cell based on channel state information (CSI) feedback is lower than a coordinated multipoint (CoMP) transmission threshold 140. The eNode B 102 may return to configuring 508 the feedback setting of the user equipment (UE) 104 for the coordinated multipoint (CoMP) transmission measurement set 130 and the second loop 522 may repeat.

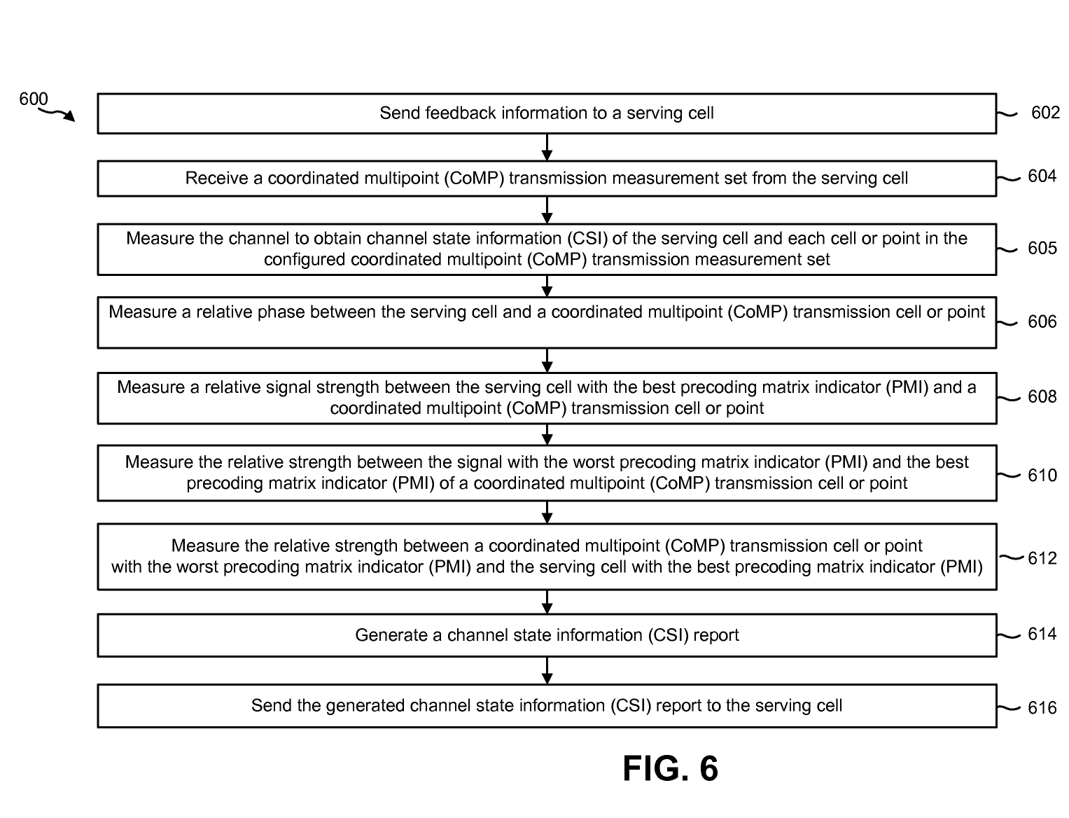

FIG. 6 is a flow diagram of a method 600 for sending feedback corresponding to coordinated multipoint (CoMP) transmission operations. The method 600 may be performed by a user equipment (UE) 104. The user equipment (UE) 104 may send 602 feedback information to a serving cell 248. The feedback information may include the measured reference signal received power (RSRP) 134 of neighbor cells or points and the measured reference signal received quality (RSRQ) 136 of neighbor cells or points. The user equipment (UE) 104 may then receive 604 a coordinated multipoint (CoMP) transmission measurement set 130 from the serving cell 248. Because the channel state information reference signal (CSI-RS) and the common reference signal (CRS) of each cell or point can be configured independently, the channel state information (CSI) of each cell or point can be obtained independently.

The user equipment (UE) 104 may then measure 605 the channel to obtain channel state information (CSI) of the serving cell 248 and each cell or point in the configured coordinated multipoint (CoMP) transmission measurement set 130. The channel state information (CSI) may include the rank indication (RI), the best precoding matrix indicator (PMI) 122 (i.e., the precoding matrix indicator (PMI) 122 that provides the best received signal), the signal strength and channel quality indicator (CQI) with the best precoding matrix indicator (PMI) 122, the worst precoding matrix indicator (PMI) 124 (i.e., the precoding matrix indicator (PMI) that provides the worst received signal), the signal strength and channel quality indicator (CQI) with the worst precoding matrix indicator (PMI) 123, etc.

For example, for each coordinated multipoint (CoMP) transmission cell or point 250 in the coordinated multipoint (CoMP) transmission measurement set 130, the user equipment may measure 606 a relative phase 116 between the best precoding matrix indicator (PMI) 122 of the serving cell 248 and the best precoding matrix indicator (PMI) 122 of the coordinated multipoint (CoMP) transmission cell or point 250. If joint processing (JP) with joint transmission (JT) is selected as the coordinated multipoint (CoMP) transmission method for a coordinated multipoint (CoMP) transmission cell or point 250, the relative phase 116 between the best precoding matrix indicator (PMI) 122 of the serving cell 248 and the best precoding matrix indicator (PMI) 122 of a coordinated multipoint (CoMP) transmission cell or point 250 may be used to align the signals from different cells. The relative phase 116 between the best precoding matrix indicator (PMI) 122 of the serving cell 248 and the best precoding matrix indicator (PMI) 122 of a coordinated multipoint (CoMP) transmission cell or point 250 may be represented by a quantized feedback with a different number of bits from uniform or non-linear quantization methods.

For each coordinated multipoint (CoMP) transmission cell or point 250 in the coordinated multipoint (CoMP) transmission measurement set 130, the user equipment (UE) 104 may also measure 608 a relative signal strength 120 between the serving cell 248 with the best precoding matrix indicator (PMI) 122 and the coordinated multipoint (CoMP) transmission cell or point 250. The relative signal strength 120 between the serving cell 248 with the best precoding matrix indicator (PMI) 122 and the coordinated multipoint (CoMP) transmission cell or point 250 may be represented by a differential channel quality indicator (CQI) between the serving cell 248 and the coordinated multipoint (CoMP) transmission cell or point 250. The relative signal strength 120 between the serving cell 248 with the best precoding matrix indicator (PMI) 122 and the coordinated multipoint (CoMP) transmission cell or point 250 may also be represented by a quantized feedback of the ratio of the power or amplitude of the signal based on the best precoding matrix indicator (PMI) 122 of the coordinated multipoint (CoMP) transmission cell or point 250 and the power or amplitude of the signal based on the best precoding matrix indicator (PMI) 122 of the serving cell 248. Thus, the relative signal strength 120 between the serving cell 248 with the best precoding matrix indicator (PMI) 122 and the coordinated multipoint (CoMP) transmission cell or point 250 may be Pc_max/Ps_max, where Pc_max is the received power of a coordinated multipoint (CoMP) transmission cell or point 250 with the best precoding matrix indicator (PMI) 122 of the given cell and Ps_max is the received power of the serving cell 248 with the best precoding matrix indicator (PMI) 122. If no coordination is applied, Pc_max indicates the maximum interference from a coordinated multipoint (CoMP) transmission cell or point 250.

The relative signal strength 120 between the serving cell 248 with the best precoding matrix indicator (PMI) 122 and the coordinated multipoint (CoMP) transmission cell or point 250 may also be Ps_max/Pc_max. The relative signal strength 120 between the serving cell 248 with the best precoding matrix indicator (PMI) 122 and the coordinated multipoint (CoMP) transmission cell or point 250 may indicate the interference from a coordinated multipoint (CoMP) transmission cell or point 250, and what channel quality indicator (CQI) level drop is expected with the interference. The channel quality indicator (CQI) feedback of Release 10 represents the signal quality at the receiver; mathematically, it is a quantized feedback of Ps_max/noise, where the noise includes interference from neighbor cells.

For each coordinated multipoint (CoMP) transmission cell or point 250 in the coordinated multipoint (CoMP) transmission measurement set 130, the user equipment (UE) 104 may also measure 610 the relative strength 126 between the signal with the worst precoding matrix indicator (PMI) 124 and the best precoding matrix indicator (PMI) 122 of the coordinated multipoint (CoMP) transmission cell or point 250. The relative strength 126 between the signal with the worst precoding matrix indicator (PMI) 124 and the best precoding matrix indicator (PMI) 122 of the coordinated multipoint (CoMP) transmission cell or point 250 may be represented by a quantized feedback of the ratio of the power or amplitude of the signal based on the worst precoding matrix indicator (PMI) 124 of the coordinated multipoint (CoMP) transmission cell or point 250 and the power or amplitude of the signal based on the best precoding matrix indicator (PMI) 122 of the same coordinated multipoint (CoMP) transmission cell or point 250, i.e., Pc_min/Pc_max or Pc_max/Pc_min, where Pc_min is the received power of the coordinated multipoint (CoMP) transmission cell or point 250 with the worst precoding matrix indicator (PMI) 124 of the given cell. Pc_min may indicate the minimum interference from a coordinated multipoint (CoMP) transmission cell or point 250 if coordinated scheduling/coordinated beamforming (CS/CB) is applied.

If a subset of precoding matrix indicators (PMIs) is provided as the worst precoding matrix indicator (PMI) 124, the power or amplitude of the worst precoding matrix indicator (PMI) 124 may be the maximum power or amplitude of the given subset. Alternatively, if a subset of precoding matrix indicators (PMIs) is provided as the worst precoding matrix indicator (PMI) 124, the average power or average amplitude of the precoding matrix indicator (PMI) subset may be used as the worst precoding matrix indicator (PMI) 124.

For each coordinated multipoint (CoMP) transmission cell or point 250 in the coordinated multipoint (CoMP) transmission measurement set 130, the user equipment (UE) 104 may also measure 612 the relative strength 128 between the coordinated multipoint (CoMP) transmission cell or point 250 with the worst precoding matrix indicator (PMI) 124 and the serving cell 248 with the best precoding matrix indicator (PMI) 122. The relative strength 128 between the coordinated multipoint (CoMP) transmission cell or point 250 with the worst precoding matrix indicator (PMI) 124 and the serving cell 248 with the best precoding matrix indicator (PMI) 122 may be represented by a differential channel quality indicator (CQI) or by a quantized feedback based on the ratio of the power or amplitude of the signal based on the worst precoding matrix indicator (PMI) 124 of the coordinated multipoint (CoMP) transmission cell or point 250 and the power or amplitude of the signal based on the best precoding matrix indicator (PMI) 122 of the serving cell 248. For example, the relative strength 128 between the coordinated multipoint (CoMP) transmission cell or point 250 with the worst precoding matrix indicator (PMI) 124 and the serving cell 248 with the best precoding matrix indicator (PMI) 122 may be Pc_min/Ps_max or Ps_max/Pc_min. If a subset of precoding matrix indicators (PMIs) is provided as the worst precoding matrix indicator (PMI) 124, the power or amplitude of the worst precoding matrix indicator (PMI) 124 may be the maximum power or amplitude of the given subset. Alternatively, if a subset of precoding matrix indicators (PMIs) is provided as the worst precoding matrix indicator (PMI) 124, the power or amplitude of the worst precoding matrix indicator (PMI) 124 may be the average power or the average amplitude of the given subset.

If the relative strength 126 between the signal with the best precoding matrix indicator (PMI) 122 and the worst precoding matrix indicator (PMI) 124 is reported by the user equipment (UE) 104, the user equipment (UE) 104 may not need to report the relative strength 128 between the coordinated multipoint (CoMP) transmission cell or point 250 with the worst precoding matrix indicator (PMI) 124 and the serving cell 248 with the best precoding matrix indicator (PMI) 122 (as this information can be obtained from the relative strength 126 between the signal with the best precoding matrix indicator (PMI) 122 and the worst precoding matrix indicator (PMI) 124). Likewise, if the relative strength 128 between the coordinated multipoint (CoMP) transmission cell or point 250 with the worst precoding matrix indicator (PMI) 124 and the serving cell 248 with the best precoding matrix indicator (PMI) 122 is reported by the user equipment (UE) 104, the user equipment (UE) 104 may not need to report the relative strength 126 between the signal with the best precoding matrix indicator (PMI) 122 and the worst precoding matrix indicator (PMI) 124.

In one configuration, only some of the measured channel state information (CSI) related to each coordinated multipoint (CoMP) transmission cell or point 250 are needed by the serving cell 248. For example, the relative signal strength 120 between a coordinated multipoint (CoMP) transmission cell or point 250 and the serving cell 248 with the best precoding matrix indicator (PMI) 122 and either the relative strength 126 between the signal with the best precoding matrix indicator (PMI) 122 and the worst precoding matrix indicator (PMI) 124 or the relative strength 128 between a coordinated multipoint (CoMP) transmission cell or point 250 with the worst precoding matrix indicator (PMI) 124 and the serving cell 248 with the best precoding matrix indicator (PMI) 122 may be needed by the serving cell 248 to estimate the channel quality when a coordinated multipoint (CoMP) transmission method is applied.

Before coordinated multipoint (CoMP) transmission is configured, a user equipment (UE) 104 may use the reference signal received power (RSRP) 134 and the reference signal received quality (RSRQ) 136 to evaluate if coordinated multipoint (CoMP) transmission should be used, and if yes, which cells should be included in the coordinated multipoint (CoMP) transmission measurement set 130. The user equipment (UE) 104 may obtain the reference signal received power (RSRP) 134 and the reference signal received quality (RSRQ) 136 mainly for handoff operations.

In general, if the reference signal received power (RSRP) 134 of a neighbor cell is high, the interference to the user equipment (UE) 104 is high and it may be better to use coordinated multipoint (CoMP) transmission. If the reference signal received power (RSRP) 134 is high but the reference signal received quality (RSRQ) 136 is low, it may be better to use coordinated scheduling/coordinated beamforming (CS/CB) rather than joint processing (JP) (such as joint transmission (JT)), since the channel quality is not good. However, the reference signal received power (RSRP) 134 and reference signal received quality (RSRQ) 136 give only a rough measurement. Thus, the eNode B 102 should configure a coordinated multipoint (CoMP) transmission measurement set 130 to obtain more detailed channel state information (CSI) prior to configuring coordinated multipoint (CoMP) transmission.

The user equipment (UE) 104 may generate 614 a channel state information (CSI) report 112 of the measured channel state information (CSI) for each coordinated multipoint (CoMP) transmission cell or point 250 of the coordinated multipoint (CoMP) transmission measurement set 130. The user equipment (UE) 104 may then send 616 the generated channel state information (CSI) report 112 to the serving cell 248.

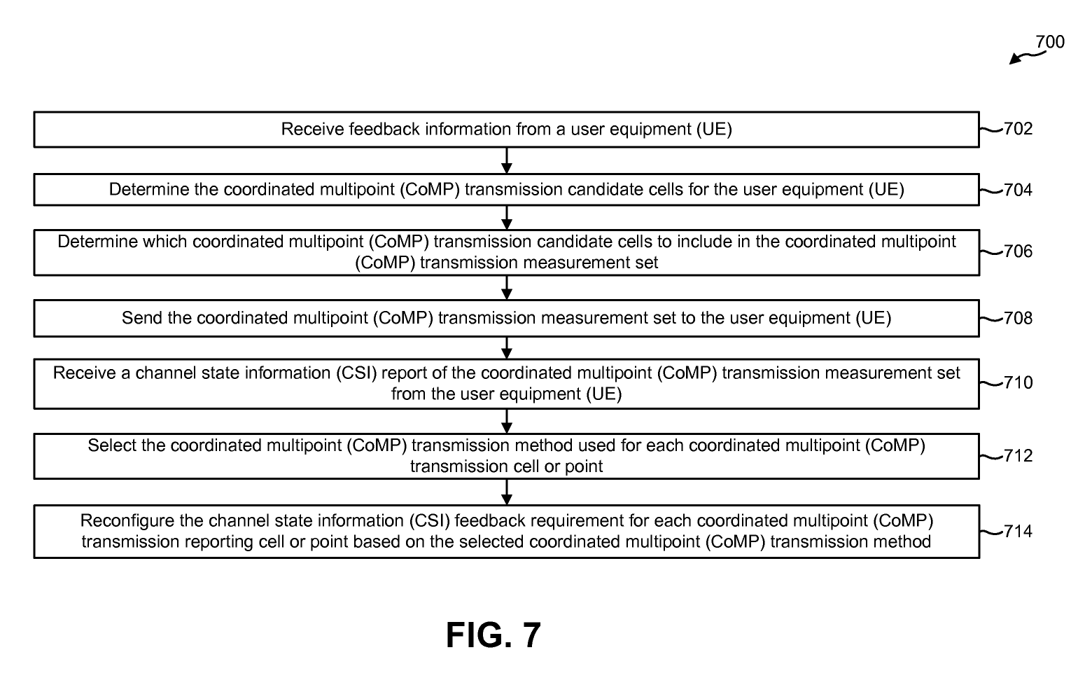

FIG. 7 is a flow diagram of a method 700 for configuring coordinated multipoint (CoMP) transmission. The method 700 may be performed by an eNode B 102. In one configuration, the eNode B 102 may be a serving cell 248. The eNode B 102 may receive 702 feedback information from a user equipment (UE) 104. Based on the feedback information, the eNode B 102 can estimate the channel quality when different coordinated multipoint (CoMP) transmission methods are applied.

For example, the expected signal-to-noise ratio (SNR) can be estimated as Ps_max/(Pc_max+noise) for no coordinated multipoint (CoMP) transmission applied. As another example, the expected signal-to-noise ratio (SNR) can be estimated as Ps_max/(Pc_min+noise) for coordinated scheduling/coordinated beamforming (CS/CB). As yet another example, the expected signal-to-noise ratio (SNR) can be estimated as (Ps_max+Pc_max)/noise for joint processing (JP) with joint transmission (JT). As yet another example, the expected signal-to-noise ratio (SNR) may be estimated as max(Ps_max, Pc_max)/noise for joint processing (JP) with dynamic point selection (DPS). The noise in these examples may also include the interference from other coordinated multipoint (CoMP) transmission cells or points 250 and neighbor cells. The signal-to-noise ratio (SNR) may be iteratively calculated for all user equipment (UE) 104 measurements to obtain a global optimization at the eNode B 102 of coordinated cells.

Upon receiving the feedback information from a user equipment (UE) 104 (the neighbor cell list of a user equipment (UE) 104), the eNode B 102 may determine 704 the coordinated multipoint (CoMP) transmission candidate cells for the user equipment (UE) 104. The eNode B 102 may then determine 706 which coordinated multipoint (CoMP) transmission candidate cells to include in the coordinated multipoint (CoMP) transmission measurement set 130. The eNode B 102 may send 708 the coordinated multipoint (CoMP) transmission measurement set 130 to the user equipment (UE) 104.

The eNode B 102 may receive 710 a channel state information (CSI) report of the coordinated multipoint (CoMP) transmission measurement set 130 from the user equipment (UE) 104. The eNode B 102 may select 712 the coordinated multipoint (CoMP) transmission method used for each neighbor cell that coordinated multipoint (CoMP) transmission has been enabled for.

The eNode B 102 may also reconfigure 714 the channel state information reference signal (CSI-RS) feedback requirement for each coordinated multipoint (CoMP) transmission reporting cell or point based on the selected coordinated multipoint (CoMP) transmission method. As discussed above, the user equipment (UE) 104 may send a feedback channel state information (CSI) report for a cell or point. The channel state information (CSI) report may include rank indication (RI), a channel quality indicator (CQI) and the precoding matrix indicator (PMI). The precoding matrix indicator (PMI) sent may be the precoding matrix indicator (PMI) that gives the best received signal quality (i.e., the best precoding matrix indicator (PMI) 122),

The channel quality indicator (CQI) may be reported for each layer (the number of layers equals the rank) based on the best precoding matrix indicator (PMI) 122. If the eNode B 102 configured different coordinated multipoint (CoMP) methods for different coordinated multipoint (CoMP) cells 250, the feedback requirements may be different. For a coordinated multipoint (CoMP) cell 250 that uses coordinated scheduling/coordinated beamforming (CS/CB), the user equipment (UE) 104 may feedback the rank indication (RI), the worst precoding matrix indicator (PMI) 124, the relative channel quality indicator (CQI) for the signal strength between the best precoding matrix indicator (PMI) 122 and the worst precoding matrix indicator (PMI) 124 of the cell, etc. For a coordinated multipoint (CoMP) transmission cell or point 250 that uses joint processing (JP), the user equipment (UE) 104 may feedback the rank indication (RI) and the channel quality indicator (CQI) with the best precoding matrix indicator (PMI) 122. For joint processing (JP) with joint transmission (JT), the relative phase and power between the coordinated multipoint (CoMP) transmission cell or point 250 and the serving cell 248 may also be reported. For joint processing (JP) with dynamic point selection (DPS), the relative phase and power between the coordinated multipoint (CoMP) transmission cell or point 250 and the serving cell is not necessary to be reported.

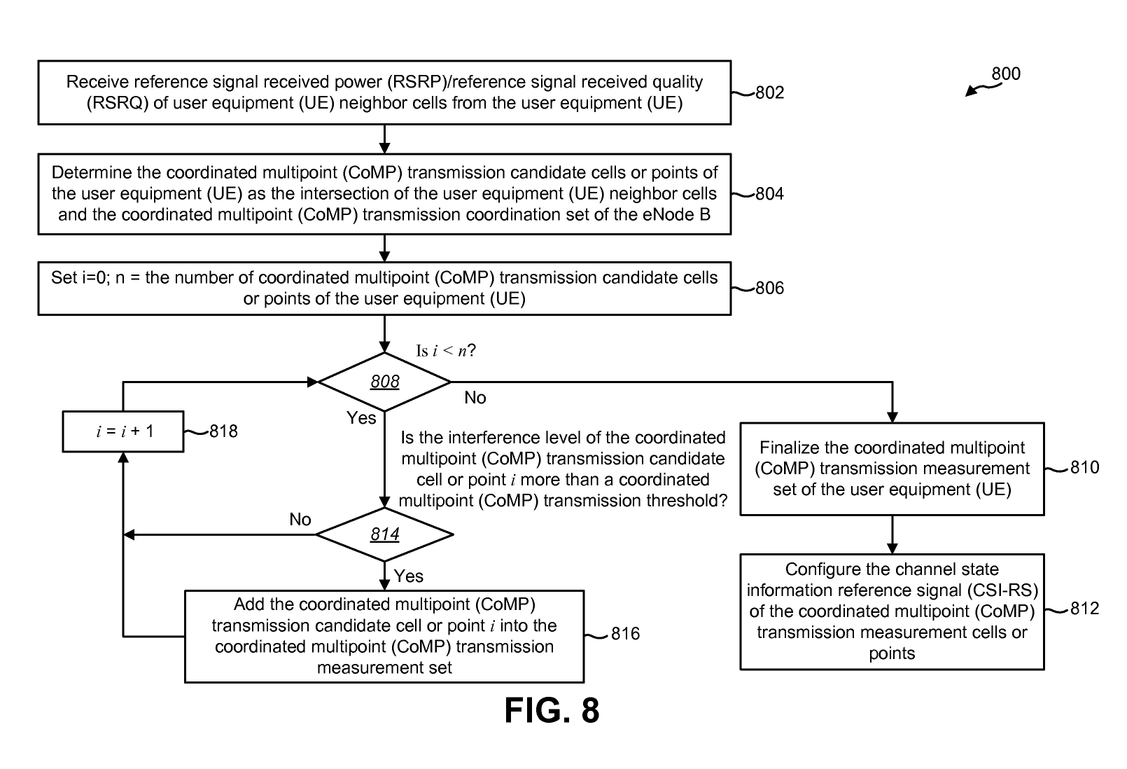

FIG. 8 is a flow diagram of a method 800 for determining which coordinated multipoint (CoMP) transmission candidate cells or points 250 to be included in the coordinated multipoint (CoMP) transmission measurement set 130. The coordinated multipoint (CoMP) transmission measurement set 130 may also be referred to as the control signaling points. The method 800 may be performed by an eNode B 102. The eNode B 102 may receive 802 the reference signal received power (RSRP) 134/reference signal received quality (RSRQ) 136 of user equipment (UE) 104 neighbor cells from the user equipment (UE) 104. The eNode B 102 may determine 804 the coordinated multipoint (CoMP) transmission candidate cells or points of the user equipment (UE) 104 as the intersection of the user equipment (UE) 104 neighbor cells and the coordinated multipoint (CoMP) transmission coordination set of the eNode B 102.

The eNode B 102 may set 806 i=0 and n=the number of coordinated multipoint (CoMP) transmission candidate cells or points of the user equipment (UE) 104. The eNode B 102 may then determine 808 whether i<n. If i≧n, the eNode B 102 may finalize 810 the coordinated multipoint (CoMP) transmission measurement set 130 of the user equipment (UE) 104 as those coordinated multipoint (CoMP) transmission candidate cells or points that have been added to the coordinated multipoint (CoMP) transmission measurement set 130 of the user equipment (UE) 104. The eNode B 102 may then configure 812 the channel state information reference signal (CSI-RS) of the coordinated multipoint (CoMP) transmission measurement set 130 cells or points.

If i<n, the eNode B 102 may determine 814 whether the interference level of the coordinated multipoint (CoMP) transmission candidate cell or point i is more than a coordinated multipoint (CoMP) transmission threshold 140. If the interference level of the coordinated multipoint (CoMP) transmission candidate cell or point i is not more than the coordinated multipoint (CoMP) transmission threshold 140, the eNode B 102 may increment 818 i=i+1 and return to determining 808 whether i<n. If the interference level of the coordinated multipoint (CoMP) transmission candidate cell or point i is more than the coordinated multipoint (CoMP) transmission threshold 140, the eNode B 102 may add 816 the coordinated multipoint (CoMP) transmission cell or point i to the coordinated multipoint (CoMP) transmission measurement set 130. The eNode B 102 may then increment 818 i=i+1 and return to determining 808 whether i<n.

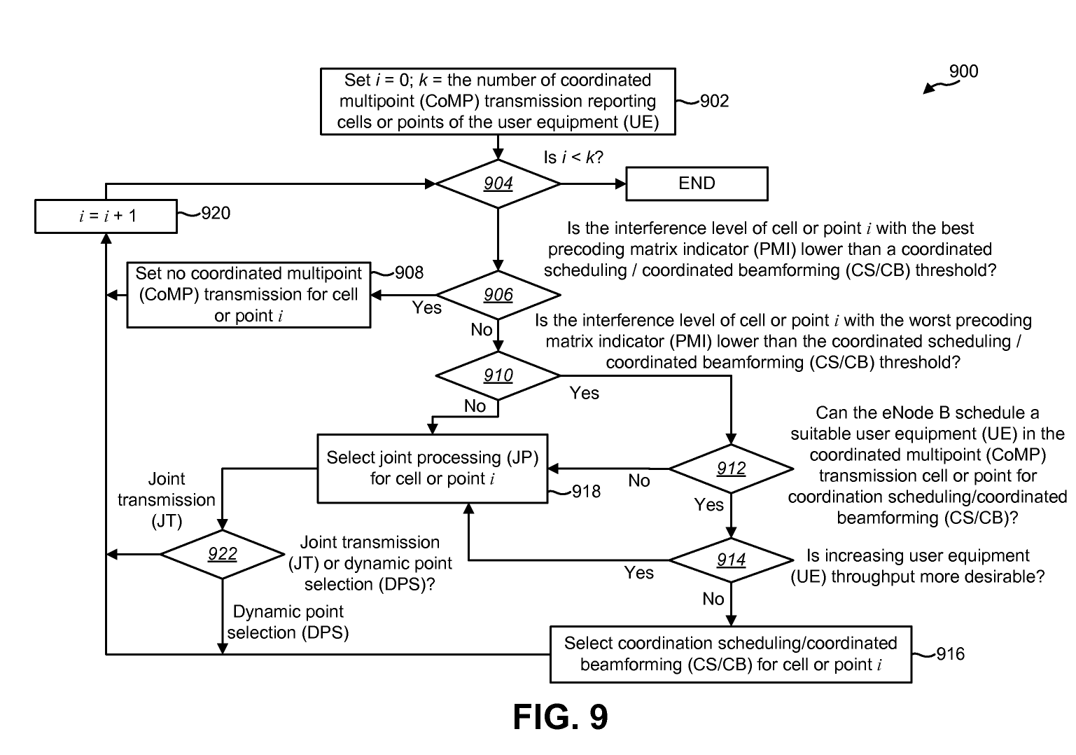

FIG. 9 is a flow diagram of a method 900 for selecting a coordinated multipoint (CoMP) transmission method for a coordinated multipoint (CoMP) transmission cell or point 250. The method 900 may be performed by an eNode B 102. The eNode B 102 may set 902 i=0 and k=the number of coordinated multipoint (CoMP) transmission reporting cells or points of the user equipment (UE) 104. The eNode B 102 may then determine 904 whether i<k. If i is not <k, the method 900 may end (as there are no more coordinated multipoint (CoMP) transmission reporting cells or points of the user equipment (UE) 104 to configure). If i<k, the eNode B 102 may determine 906 whether the interference level of the coordinated multipoint (CoMP) transmission cell or point i 250 with the best precoding matrix indicator (PMI) 122 is lower than a coordinated scheduling/coordinated beamforming (CS/CB) threshold 142. The interference level may be evaluated using the relative strength 126 between the signal of a coordinated multipoint (CoMP) transmission cell or point 250 with the best precoding matrix indicator (PMI) 122 (of the coordinated multipoint (CoMP) transmission cell or point 250) and the signal of the serving cell 248 with the best precoding matrix indicator (PMI) 122 (of the serving cell 248) (i.e., Pc_max/Ps_max).

If the interference level of the coordinated multipoint (CoMP) transmission cell or point i 250 with the best precoding matrix indicator (PMI) 122 is lower than the coordinated scheduling/coordinated beamforming (CS/CB) threshold 142, then the interference is low enough that no coordinated multipoint (CoMP) transmission method is needed for this cell or point and the eNode B 102 may set 908 no coordinated multipoint (CoMP) transmission for the coordinated multipoint (CoMP) transmission cell or point i 250. The user equipment (UE) 104 may then increment 9201=i+1 and return to determining 904 whether i<k. If the interference level of the coordinated multipoint (CoMP) transmission cell or point i 250 with the best precoding matrix indicator (PMI) 122 is not lower than the coordinated scheduling/coordinated beamforming (CS/CB) threshold 142, the eNode B 102 may determine 910 whether the interference level of the coordinated multipoint (CoMP) transmission cell or point i 250 with the worst precoding matrix indicator (PMI) 124 is lower than the coordinated scheduling/coordinated beamforming (CS/CB) threshold 142. The interference level of the coordinated multipoint (CoMP) transmission cell or point i 250 with the worst precoding matrix indicator (PMI) 124 may be evaluated using the relative strength 126 between the signal of a coordinated multipoint (CoMP) transmission cell or point 250 with the worst precoding matrix indicator (PMI) 124 (of the coordinated multipoint (CoMP) transmission cell or point 250) and the signal of the serving cell 248 with the best precoding matrix indicator (PMI) 122 (of the serving cell 248) (i.e., Pc_min/Ps_max).

The interference level of the coordinated multipoint (CoMP) transmission cell or point i 250 with the worst precoding matrix indicator (PMI) 124 may be obtained from the relative strength 128 between a coordinated multipoint (CoMP) transmission cell or point 250 with the worst precoding matrix indicator (PMI) 124 and the serving cell 248 with the best precoding matrix indicator (PMI) 122 if reported by the user equipment (UE) 104 to the eNode B 102. Alternatively, if the user equipment (UE) 104 has not reported the relative strength 128 between a coordinated multipoint (CoMP) transmission cell or point 250 with the worst precoding matrix indicator (PMI) 124 and the serving cell 248 with the best precoding matrix indicator (PMI) 122, the eNode B 102 may calculate the interference level of the coordinated multipoint (CoMP) transmission cell or point i 250 with the worst precoding matrix indicator (PMI) 124 using the relative signal strength 120 between a serving cell 248 with the best precoding matrix indicator (PMI) 122 and the coordinated multipoint (CoMP) transmission cell or point 250 and the relative strength 126 between the signal with the best precoding matrix indicator (PMI) 122 and the worst precoding matrix indicator (PMI) 122 if both are reported to the eNode B 102 by the user equipment (UE) 104.

If the interference level of the coordinated multipoint (CoMP) transmission cell or point i 250 with the worst precoding matrix indicator (PMI) 124 is not lower than the coordinated scheduling/coordinated beamforming (CS/CB) threshold 142, the eNode B 102 may select 918 joint processing (JP) for the coordinated multipoint (CoMP) transmission cell or point i 250. If the interference level of the coordinated multipoint (CoMP) transmission cell or point i 250 with the worst precoding matrix indicator (PMI) 124 is lower than the coordinated scheduling/coordinated beamforming (CS/CB) threshold 142, the eNode B 102 may determine 912 whether the eNode B 102 can schedule a suitable user equipment (UE) 104 in the coordinated multipoint (CoMP) transmission cell or point 250 for coordinated scheduling/coordinated beamforming (CS/CB).

If the eNode B 102 can not schedule a suitable user equipment (UE) 104 in the coordinated multipoint (CoMP) transmission cell or point 250 for coordinated scheduling/coordinated beamforming (CS/CB) (i.e., no user equipment (UE) 104 in the coordinated multipoint (CoMP) transmission cell or point 250 can use PMIc_min), the eNode B 102 may select 918 joint processing (JP) for the coordinated multipoint (CoMP) transmission cell or point i 250. If the eNode B 102 can schedule a suitable user equipment (UE) 104 in the coordinated multipoint (CoMP) transmission cell or point 250 for coordinated scheduling/coordinated beamforming (CS/CB), the eNode B 102 may determine 914 whether increasing user equipment (UE) 104 throughput is more desirable than scheduling another user equipment (UE) 104 transmission and increasing the overall spectrum utilization. If increasing user equipment (UE) 104 throughput is more desirable, the eNode B 102 may select 918 joint processing (JP) for the coordinated multipoint (CoMP) transmission cell or point i 250.

For joint processing (JP), the eNode B 102 may further select 922 either joint transmission (JT) or dynamic point selection (DPS) for the coordinated multipoint (CoMP) transmission cell or point i 250, based on the interference level estimation. Joint transmission (JT) may achieve higher throughput with a combined maximum received power of (Ps_max+Pc_max), but may need extra feedback information such as the relative phase 116 between the serving cell and the coordinated multipoint (CoMP) transmission cell or point i 250. Dynamic point selection (DPS) may choose only one point for transmission, with a received power of max(Ps_max, Pc_max), and thus may have a lower throughput than joint transmission (JT) but does not require extra feedback such as the relative phase 116 between the serving cell 248 and the coordinated multipoint (CoMP) transmission cell or point i 250. Thus, the decision may be made based on the target throughput and feedback complexity tradeoff. After selecting 922 either joint transmission (JT) or dynamic point selection (DPS) with joint processing (JP), the eNode B 102 may increment 920 i=i+1 and return to determining 904 if i<k.

If scheduling another user equipment (UE) 104 transmission and increasing the overall spectrum utilization is more desirable, the eNode B 102 may select 916 coordinated scheduling/coordinated beamforming (CS/CB) for the coordinated multipoint (CoMP) transmission cell or point i 250.

Once the eNode B 102 has selected 916 coordinated scheduling/coordinated beamforming (CS/CB) for the coordinated multipoint (CoMP) transmission cell or point i 250, the eNode B 102 may increment 920 i=i+1 and return to determining 904 if i<k. Once the eNode B 102 has selected 918 joint transmission (JT) for the coordinated multipoint (CoMP) transmission cell or point i 250, the eNode B 102 may increment 920 i=i+1 and return to determining 904 if i<k.

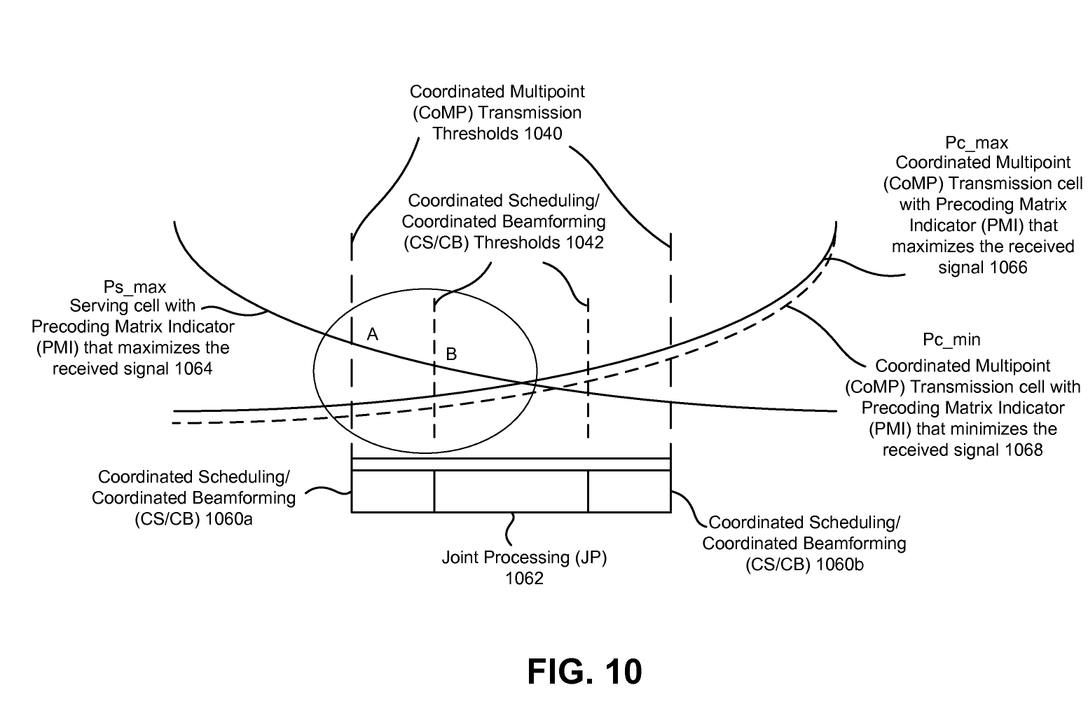

FIG. 10 illustrates the coordinated multipoint (CoMP) transmission method selection of an eNode B 102. The eNode B 102 may select between coordinated scheduling/coordinated beamforming (CS/CB) 1060a-b and joint processing (JP) 1062 as coordinated multipoint (CoMP) transmission methods. A plot is shown of Ps_max 1064, the serving cell 248 with precoding matrix indicator (PMI) that maximizes the received signal. Also shown is a plot of Pc_max 1066, the coordinated multipoint (CoMP) transmission cell or point 250 with precoding matrix indicator (PMI) that maximizes the received signal. The plotting is also shown of Pc_min 1068, the coordinated multipoint (CoMP) transmission cell or point 250 with precoding matrix indicator (PMI) that minimizes the received signal.

If a user equipment (UE) 104 is on the right half side of the graph, the eNode B 102 on the right side should become the serving cell 248. If the user equipment (UE) 104 is on the left half side of the graph, the eNode B 102 on the left side is the serving cell 248. A threshold Th1 may be defined as the coordinated multipoint (CoMP) transmission threshold 1040. We may use

$$x == \frac{( Pc\_max + n )}{Ps\_max} ,$$

where n is the noise/interference observed (which includes interference from coordinated multipoint (CoMP) transmission cells or points 250 other than shown in the graph). If x<Th1, the interference from a coordinated multipoint (CoMP) transmission cell or point 250 is small enough that coordinated multipoint (CoMP) transmission is not needed for the cell or point.

If x>Th1, the interference from the given coordinated multipoint (CoMP) transmission cell or point 250 may cause problems if the best precoding matrix indicator (122) is used in the coordinated multipoint (CoMP) transmission cell or point 250. Thus, some coordinated multipoint (CoMP) transmission should be used. Point A in the graph shows the threshold for whether to use coordinated multipoint (CoMP) transmission or not. If coordinated multipoint (CoMP) transmission is used, the eNode B 102 may evaluate the interference caused by the coordinated multipoint (CoMP) transmission cells or points 250 when the worst precoding matrix indicator (PMI) 124 is used.

It may be assumed that another threshold Th2 is configured as the coordinated scheduling/coordinated beamforming (CS/CB) threshold 1042. Th2 may or may not be the same as Th1. We may use

$$y == \frac{( Pc\_max + n )}{Ps\_max} ,$$

where y is the interference level when the worst precoding matrix indicator (PMI) 124 is used. Since Ps_min is less than Ps_max, the interference is reduced by choosing the worst precoding matrix indicator (PMI) 124 in the coordinated multipoint (CoMP) transmission cell or point 250. If y<Th2, coordinated scheduling/coordinated beamforming (CS/CB) may be used to successfully reduce the interference level. Thus, coordinated scheduling/coordinated beamforming (CS/CB) may be used if another user equipment (UE) 104 in the coordinated multipoint (CoMP) transmission cell or point 250 has a best precoding matrix indicator (PMI) 122 that matches the worst precoding matrix indicator (PMI) 124 for the given user equipment (UE) 104.

If increasing the user equipment (UE) 104 throughput is more desirable, or if there is no user equipment (UE) 104 in the coordinated multipoint (CoMP) transmission cell or point 250 that can use the worst precoding matrix indicator (PMI) 124 of the given user equipment (UE) 104, the eNode B 102 may select joint processing (JP) as the coordinated multipoint (CoMP) transmission method. If y>Th2, coordinated scheduling/coordinated beamforming (CS/CB) with the worst precoding matrix indicator (PMI) 124 still cannot reduce the interference to an acceptable level and joint processing (JP) should be used. This is point B in the graph (i.e., the coordinated scheduling/coordinated beamforming (CS/CB) threshold 142. The graph of FIG. 10 shows the required measurements and feedback to support the method 900 of FIG. 9.

For joint processing (JP), the eNode B 102 may further select 922 either joint transmission (JT) or dynamic point selection (DPS) for the coordinated multipoint (CoMP) transmission cell or point 250,

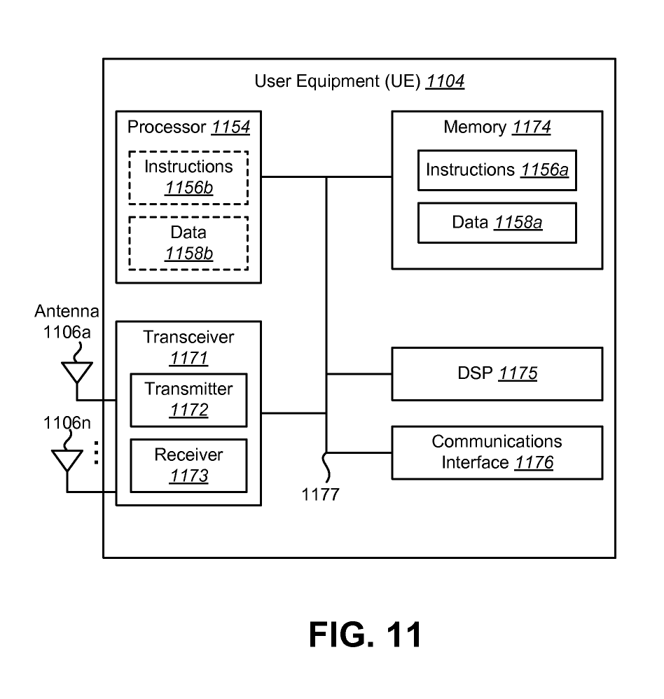

FIG. 11 illustrates various components that may be utilized in a user equipment (UE) 1104. The user equipment (UE) 1104 may be utilized as the user equipment (UE) 104 illustrated previously. The user equipment (UE) 1104 includes a processor 1154 that controls operation of the user equipment (UE) 1104. The processor 1154 may also be referred to as a CPU. Memory 1174, which may include both read-only memory (ROM), random access memory (RAM) or any type of device that may store information, provides instructions 1156a and data 1158a to the processor 1154. A portion of the memory 1174 may also include non-volatile random access memory (NVRAM). Instructions 1156b and data 1158b may also reside in the processor 1154. Instructions 1156b and/or data 1158b loaded into the processor 1154 may also include instructions 1156a and/or data 1158a from memory 1174 that were loaded for execution or processing by the processor 1154. The instructions 1156b may be executed by the processor 1154 to implement the systems and methods disclosed herein.

The user equipment (UE) 1104 may also include a housing that contains a transmitter 1172 and a receiver 1173 to allow transmission and reception of data. The transmitter 1172 and receiver 1173 may be combined into a transceiver 1171. One or more antennas 1106a-n are attached to the housing and electrically coupled to the transceiver 1171.

The various components of the user equipment (UE) 1104 are coupled together by a bus system 1177, which may include a power bus, a control signal bus, and a status signal bus, in addition to a data bus. However, for the sake of clarity, the various buses are illustrated in FIG. 11 as the bus system 1177. The user equipment (UE) 1104 may also include a digital signal processor (DSP) 1175 for use in processing signals. The user equipment (UE) 1104 may also include a communications interface 1176 that provides user access to the functions of the user equipment (UE) 1104. The user equipment (UE) 1104 illustrated in FIG. 11 is a functional block diagram rather than a listing of specific components.

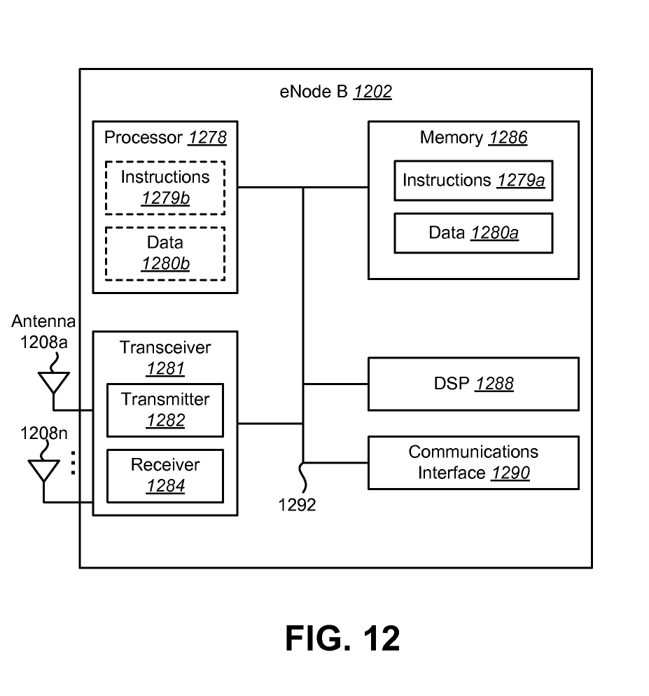

FIG. 12 illustrates various components that may be utilized in an eNode B 1202. The eNode B 1202 may be utilized as the eNode B 102 illustrated previously. The eNode B 1202 may include components that are similar to the components discussed above in relation to the user equipment (UE) 1104, including a processor 1278, memory 1286 that provides instructions 1279a and data 1280a to the processor 1278, instructions 1279b and data 1280b that may reside in or be loaded into the processor 1278, a housing that contains a transmitter 1282 and a receiver 1284 (which may be combined into a transceiver 1281), one or more antennas 1208a-n electrically coupled to the transceiver 1281, a bus system 1292, a DSP 1288 for use in processing signals, a communications interface 1290 and so forth.

Unless otherwise noted, the use of ‘/’ above represents the phrase “and/or.”

The functions described herein may be implemented in hardware, software, firmware or any combination thereof. If implemented in software, the functions may be stored as one or more instructions on a computer-readable medium. The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio, and microwave, then the coaxial cable, fiber optic cable, twisted pair, DSL, or wireless technologies such as infrared, radio and microwave are included in the definition of transmission medium.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for configuring coordinated multipoint (CoMP) transmission by an eNode B, comprising:
receiving feedback information from a user equipment (UE);
determining a CoMP transmission measurement set;
sending the CoMP transmission measurement set to the UE;
receiving a channel state information (CSI) report of the CoMP measurement set from the UE; and
selecting a CoMP transmission method used for each CoMP transmission point in the CoMP measurement set.

2. The method of claim 1, further comprising reconfiguring feedback requirements for each CoMP transmission point based on the selected CoMP transmission method used for each CoMP transmission point.

3. The method of claim 1, wherein the feedback information comprises a reference signal received power (RSRP) and a reference signal received quality (RSRQ).

4. The method of claim 1, wherein determining a CoMP transmission measurement set comprises:
determining CoMP transmission candidate points of the UE; and
adding a CoMP transmission candidate point to the CoMP transmission measurement set if an interference level of the CoMP transmission candidate point is more than a CoMP transmission threshold.

5. The method of claim 1, further comprising configuring a channel state information reference signal (CSI-RS) of the CoMP transmission points in the CoMP transmission measurement set.

6. The method of claim 1, wherein selecting a CoMP transmission method comprises determining whether an interference level of a CoMP transmission point with a best precoding matrix indicator (PMI) is lower than a coordinated beamforming/coordinated scheduling (CS/CB) threshold.

7. The method of claim 6, wherein the interference level of the CoMP transmission point with a best PMI is lower than the CS/CB threshold, and further comprising setting no CoMP transmission method for the CoMP transmission point.

8. The method of claim 6, wherein the interference level of the CoMP transmission point with a best PMI is not lower than the CS/CB threshold, and further comprising determining whether an interference level of the CoMP transmission point with a worst PMI is lower than the CS/CB threshold.

9. The method of claim 8, wherein the interference level of the CoMP transmission point with a worst PMI is not lower than the CS/CB threshold, and wherein joint processing (JP) is selected as the CoMP transmission method.

10. The method of claim 9, further comprising selecting between joint transmission (JT) and dynamic point selection (DPS) as a CoMP transmission sub-method.

11. The method of claim 8, wherein the interference level of the CoMP transmission point with a worst PMI is lower than the CS/CB threshold, and further comprising determining whether the eNode B can schedule a suitable UE in the CoMP transmission point for CS/CB.

12. The method of claim 11, wherein the eNode B can not schedule a suitable UE in the CoMP transmission point for CS/CB, and wherein joint processing (JP) is selected as the CoMP transmission method.

13. The method of claim 12, further comprising selecting between joint transmission (JT) and dynamic point selection (DPS) as a CoMP transmission sub-method.

14. The method of claim 11, wherein the eNode B can schedule a suitable UE in the CoMP transmission point for CS/CB, and further comprising determining whether increasing UE throughput is more desirable.

15. The method of claim 14, wherein increasing UE throughput is more desirable, and wherein joint processing (JP) is selected as the CoMP transmission method.

16. The method of claim 15, further comprising selecting between joint transmission (JT) and dynamic point selection (DPS) as a CoMP transmission sub-method.

17. The method of claim 14, wherein increasing UE throughput is not more desirable, and wherein CS/CB is selected as the CoMP transmission method.

18. The method of claim 1, wherein the CSI report comprises at least one of a relative phase between a serving cell and a CoMP transmission point, a relative signal strength between the serving cell with a best precoding matrix indicator (PMI) and a CoMP transmission point, a relative strength between a signal with a worst PMI and a best PMI of a CoMP transmission point and a relative strength between a CoMP transmission point with a worst PMI and a serving cell with a best PMI.

19. An eNode B for configuring coordinated multipoint (CoMP) transmission, comprising:
a processor;
memory in electronic communication with the processor; and
instructions stored in the memory, the instructions being executable to:
receive feedback information from a user equipment (UE);
determine a CoMP transmission measurement set;
send the CoMP transmission measurement set to the UE;
receive a channel state information (CSI) report of the CoMP measurement set from the UE; and
select a CoMP transmission method used for each CoMP transmission point in the CoMP measurement set.

20. The eNode B of claim 19, wherein the instructions are further executable to reconfigure feedback requirements for each CoMP transmission point based on the selected CoMP transmission method used for each CoMP transmission point.

21. The eNode B of claim 19, wherein the feedback information comprises a reference signal received power (RSRP) and a reference signal received quality (RSRQ).

22. The eNode B of claim 19, wherein the instructions executable to determine a CoMP transmission measurement set comprise instructions executable to:
determine CoMP transmission candidate points of the UE; and
add a CoMP transmission candidate point to the CoMP transmission measurement set if an interference level of the CoMP transmission candidate point is more than a CoMP transmission threshold.

23. The eNode B of claim 19, wherein the instructions are further executable to configure a channel state information reference signal (CSI-RS) of the CoMP transmission points in the CoMP transmission measurement set.

24. The eNode B of claim 19, wherein the instructions executable to select a CoMP transmission method comprise instructions executable to determine whether an interference level of a CoMP transmission point with a best precoding matrix indicator (PMI) is lower than a coordinated beamforming/coordinated scheduling (CS/CB) threshold.

25. The eNode B of claim 24, wherein the interference level of the CoMP transmission point with the best PMI is lower than the CS/CB threshold, and wherein the instructions are further executable to set no CoMP transmission method for the CoMP transmission point.

26. The eNode B of claim 24, wherein the interference level of the CoMP transmission point with the best PMI is not lower than the CS/CB threshold, and wherein the instructions are further executable to determine whether an interference level of the CoMP transmission point with a worst PMI is lower than the CS/CB threshold.

27. The eNode B of claim 26, wherein the interference level of the CoMP transmission point with the worst PMI is not lower than the CS/CB threshold, and wherein joint processing (JP) is selected as the CoMP transmission method.

28. The eNode B of claim 27, wherein the instructions are further executable to select between joint transmission (JT) and dynamic point selection (DPS) as a CoMP transmission sub-method.

29. The eNode B of claim 26, wherein the interference level of the CoMP transmission point with the worst PMI is lower than the CS/CB threshold, and wherein the instructions are further executable to determine whether the eNode B can schedule a suitable UE in the CoMP transmission point for CS/CB.

30. The eNode B of claim 29, wherein the eNode B can not schedule a suitable UE in the CoMP transmission point for CS/CB, and wherein joint processing (JP) is selected as the CoMP transmission method.

31. The eNode B of claim 30, wherein the instructions are further executable to select between joint transmission (JT) and dynamic point selection (DPS) as a CoMP transmission sub-method.

32. The eNode B of claim 29, wherein the eNode B can schedule a suitable UE in the CoMP transmission point for CS/CB, and wherein the instructions are further executable to determine whether increasing UE throughput is more desirable.

33. The eNode B of claim 32, wherein increasing UE throughput is more desirable, and wherein joint transmission (JT) is selected as the CoMP transmission method.

34. The eNode B of claim 33, wherein the instructions are further executable to select between joint processing (JP) and dynamic point selection (DPS) as a CoMP transmission sub-method.

35. The eNode B of claim 32, wherein increasing UE throughput is not more desirable, and wherein CS/CB is selected as the CoMP transmission method.

36. The eNode B of claim 19, wherein the CSI report comprises at least one of a relative phase between a serving cell and a CoMP transmission point, a relative signal strength between the serving cell with a best precoding matrix indicator (PMI) and a CoMP transmission point, a relative strength between a signal with a worst PMI and a best PMI of a CoMP transmission point and a relative strength between a CoMP transmission point with a worst PMI and a serving cell with a best PMI.

37. A method for sending feedback corresponding to coordinated multipoint (CoMP) transmission operations, comprising:
sending feedback information to a serving cell;
receiving a CoMP transmission measurement set from the serving cell;
measuring channel state information (CSI) for each CoMP transmission point in the CoMP transmission measurement set;
generating a CSI report that comprises the CSI; and
sending the CSI report to the serving cell.

38. The method of claim 37, wherein the serving cell is an eNode B.

39. The method of claim 37, wherein the feedback information comprises a reference signal received power (RSRP) and a reference signal received quality (RSRQ).

40. The method of claim 37, wherein the CSI comprises a relative phase between the serving cell and a CoMP transmission point.

41. The method of claim 37, wherein the CSI comprises a relative signal strength between the serving cell with a best precoding matrix indicator (PMI) and a CoMP transmission point.

42. The method of claim 37, wherein the CSI comprises a relative strength between a signal with a worst precoding matrix indicator (PMI) and a best PMI of a CoMP transmission point.

43. The method of claim 37, wherein the method is performed by a user equipment (UE).

44. The method of claim 43, wherein the UE is in a cell edge region, and wherein each CoMP transmission point in the CoMP transmission measurement set is a neighbor cell to the UE.

45. A user equipment (UE) configured for sending feedback corresponding to coordinated multipoint (CoMP) transmission operations, comprising:
a processor;
memory in electronic communication with the processor;
instructions stored in the memory, the instructions being executable to:
send feedback information to a serving cell;
receive a CoMP transmission measurement set from the serving cell;
measure channel state information (CSI) for each CoMP transmission point in the CoMP transmission measurement set;
generate a CSI report that comprises the CSI; and
send the CSI report to the serving cell.

46. The UE of claim 45, wherein the serving cell is an eNode B.

47. The UE of claim 45, wherein the feedback information comprises a reference signal received power (RSRP) and a reference signal received quality (RSRQ).

48. The UE of claim 45, wherein the CSI comprises a relative phase between the serving cell and a CoMP transmission point.

49. The UE of claim 45, wherein the CSI comprises a relative signal strength between the serving cell with a best precoding matrix indicator (PMI) and a CoMP transmission point.

50. The UE of claim 45, wherein the CSI comprises a relative strength between a signal with a worst precoding matrix indicator (PMI) and a best PMI of a CoMP transmission point.

51. The UE of claim 45, wherein the UE is in a cell edge region, and wherein each CoMP transmission point in the CoMP transmission measurement set is a neighbor cell to the UE.
